(19) United States
(12) Patent Application Publication
(10) Pub. No.: US 2024/0349252 A1
(43) Pub. Date: Oct. 17, 2024

(54) METHOD FOR DATA TRANSMISSION AND TERMINAL DEVICE

(71) Applicant: GUANGDONG OPPO MOBILE TELECOMMUNICATIONS CORP., LTD., Dongguan (CN)

(72) Inventors: Yi DING, Dongguan (CN); Zhenshan ZHAO, Dongguan (CN); Shichang ZHANG, Dongguan (CN); Teng MA, Dongguan (CN)

(21) Appl. No.: 18/752,722

(22) Filed: Jun. 24, 2024

Related U.S. Application Data
(63) Continuation of application No. PCT/CN2022/070396, filed on Jan. 5, 2022.

(51) Int. Cl. H04W 72/04; H04L 5/14

(52) U.S. Cl. CPC H04W 72/04; H04L 5/14

(57) ABSTRACT

A method for data transmission are provided. The method includes performing transmission using multiple resource pools on multiple carriers. The multiple carriers have a same subcarrier spacing, a same time division duplex (TDD) configuration, a same synchronization resource configuration, a same starting symbol available for sidelink (SL) transmission in a slot, and same number of symbols available for SL transmissions in a slot, and the multiple resource pools have a same physical sidelink feedback channel (PSFCH) period and a same corresponding bitmap.

### CROSS-REFERENCE TO RELATED APPLICATION(S)

This application is a continuation of International Application No. PCT/CN2022/070396, filed Jan. 5, 2022, the entire disclosure of which is incorporated herein by reference.

### TECHNICAL FIELD

Embodiments of this disclosure relate to the field of communication technologies, and in particular, to a method for data transmission and a terminal device.

### BACKGROUND

In sidelink (SL) communication, terminal devices can select a transmission resource(s) from a resource pool through sensing. In a carrier aggregation (CA) scenario where SL is supported, how to perform resource selection by a terminal device needs to be further studied.

### SUMMARY

A method for data transmission and a terminal device are provided in embodiments of the disclosure.

A method for data transmission is provided according to an aspect of embodiments of the disclosure. The method is performed by a terminal device and includes the following. Perform transmission using multiple resource pools on multiple carriers. The multiple carriers have a same subcarrier spacing, a same time division duplex (TDD) configuration, a same synchronization resource configuration, a same starting symbol available for sidelink (SL) transmission in a slot, and same number of symbols available for SL transmissions in a slot, and the multiple resource pools have a same PSFCH period and a same corresponding bitmap.

A terminal device is provided according to an aspect of embodiments of the disclosure. The terminal device includes a transceiver, a processor coupled to the transceiver, and a memory storing a computer program which, when executed by the processor, causes the terminal device to perform transmission using multiple resource pools on multiple carriers. The multiple carriers have a same subcarrier spacing, a same TDD configuration, a same synchronization resource configuration, a same starting symbol available for SL transmission in a slot, and same number of symbols available for SL transmissions in a slot, and the multiple resource pools have a same PSFCH period and a same corresponding bitmap.

A terminal device is provided according to an aspect of embodiments of the disclosure. The terminal device includes a transceiver, a processor coupled to the transceiver, and a memory storing a computer program which, when executed by the processor, causes the terminal device to exclude, in the case where a first resource in a candidate resource set or a resource corresponding to the first resource satisfies a first condition, the first resource from the candidate resource set. The first condition includes at least one of: a PSFCH resource determined according to the first resource is to cause that simultaneous PSFCH transmission exceeds a capability of simultaneous transmission; the PSFCH resource determined according to the first resource is to cause that HARQ information to be fed back exceeds a carrying capability of a PSFCH; the PSFCH resource determined according to the first resource is in conflict with a resource on which the terminal device is to perform PSFCH transmission; or the terminal device does not support transmission on the first resource or on the resource corresponding to the first resource.

Other features and aspects of the disclosed features will become apparent from the following detailed description, taken in conjunction with the accompanying drawings, which illustrate, by way of example, the features in accordance with embodiments of the disclosure. The summary is not intended to limit the scope of any embodiment described herein.

### BRIEF DESCRIPTION OF THE DRAWINGS

FIG. 1 is a schematic diagram illustrating a network architecture provided in an embodiment of the disclosure.

FIG. 2 is a schematic diagram illustrating a physical layer structure for sidelink (SL) communication provided in an embodiment of the disclosure.

FIG. 3 is a schematic diagram illustrating reservation of a time-frequency resource position provided in an embodiment of the disclosure.

FIG. 4 is a schematic diagram illustrating resource sensing and resource selection provided in an embodiment of the disclosure.

FIG. 5 is a schematic diagram illustrating resource selection in a carrier aggregation (CA) scenario provided in an embodiment of the disclosure.

FIG. 6 is a schematic diagram illustrating PSFCH resource configuration provided in an embodiment of the disclosure.

FIG. 7 is a schematic diagram illustrating determination of time-domain resources belonging to a resource pool provided in an embodiment of the disclosure.

FIG. 8 is a schematic diagram illustrating resource configuration in a CA scenario provided in an embodiment of the disclosure.

FIG. 9 is a flow chart illustrating a method for resource exclusion provided in an embodiment of the disclosure.

FIG. 10 is a schematic diagram illustrating resource exclusion in a CA scenario provided in an embodiment of the disclosure.

FIG. 11 is a flow chart illustrating a method for data transmission provided in an embodiment of the disclosure.

FIG. 12 is a block diagram illustrating an apparatus for resource exclusion provided in an embodiment of the disclosure.

FIG. 13 is a block diagram illustrating an apparatus for data transmission provided in an embodiment of the disclosure.

FIG. 14 is a schematic structural diagram illustrating a terminal device provided in an embodiment of the disclosure.

### DETAILED DESCRIPTION

In order to make purposes, technical solutions, and advantages of the disclosure clearer, the following will further describe in detail the disclosure with reference to accompanying drawings and embodiments.

Network architectures and service scenarios described in embodiments of the disclosure are intended to illustrate the technical solutions of embodiments of the disclosure more clearly and do not constitute limitation to the technical solutions of embodiments of the disclosure. It is understood by those of ordinary skill in the art that the technical solutions provided in embodiments of the disclosure are equally applicable to similar technical problems as evolution of network architectures and emergence of new service scenarios.

Refer to FIG. 1, which is a schematic diagram illustrating a network architecture according to an embodiment of the disclosure. The network architecture may include a core network 11, an access network 12, and a terminal device 13.

The core network 11 includes several core network devices. Functions of the core network device mainly include: providing user connection, managing users, and completing bearing services, where the core network device serves as a bearer network to provide an interface to an external network. For example, a core network in a 5th generation (5G) new radio (NR) system may include devices such as an access and mobility management function (AMF) entity, a user plane function (UPF) entity, and a session management function (SMF) entity.

The access network 12 includes several access network devices 14. The access network device in the 5G NR system may be referred to as a new generation-radio access network (NG-RAN). The access network device 14 is an apparatus deployed in the access network 12 to provide wireless communication functions for the terminal device 13. The access network device 14 may include macro base stations, micro base stations, relay stations, access points, and the like in various forms. In systems adopting different radio access technologies, devices with access network functions may have different names. For example, in the 5G NR system, such device is referred to as gNodeB or gNB. The expression “access network device” may change with evolution of communication technologies. For the convenience of illustration, in embodiments of the disclosure, apparatuses that provide wireless communication functions for the terminal device 13 are collectively referred to as “access network device”.

In general, there are multiple terminal devices 13, and one or more terminal devices 13 may be distributed in a cell managed by each access network device 14. The terminal device 13 may include various devices with wireless communication functions such as handheld devices, in-vehicle devices, wearable devices, computing devices, or other processing devices connected to a wireless modem, as well as user equipment (UE), mobile stations (MS), and the like in various forms. For the convenience of illustration, such devices are collectively referred to as “terminal device”. The access network device 14 and the core network device communicate with each other by using a certain air interface technology, such as an NG interface in the 5G NR system. The access network device 14 and the terminal device 13 communicate with each other by using a certain air interface technology, such as a UE-universal mobile telecommunication system (UMTS) terrestrial radio access network (UE-UTRAN, Uu) interface.

The terminal device 13 and the terminal device 13 (for example, an in-vehicle device and another device (for example, another in-vehicle device, a mobile phone, a road side unit (RSU), etc.) may communicate with each other by using a direct communication interface (for example, a proximity-based service (ProSe) communication 5 (PC5) interface). Correspondingly, a communication link established based on the direct communication interface may be referred to as a direct link or a sidelink (SL). SL transmission is direct communication data transmission between a terminal device and a terminal device by means of SL. Unlike the traditional cellular system in which communication data is received or transmitted by an access network device, the SL transmission has features of short time delay, low overhead, etc., and is suitable for communication between two terminal devices close to each other in a geographical position (such as an in-vehicle device and other peripheral devices close to the in-vehicle device in a geographical position). It may be noted that, in FIG. 1, vehicle-to-vehicle communication in a vehicle to everything (V2X) scenario is only used as an example, and SL technologies may be applied to scenarios in which direct communication is performed among various terminal devices. In other words, the terminal device in the disclosure refers to any one device that uses the SL technologies to communicate.

The “5G NR system” in embodiments of the disclosure may also be referred to as a 5G system or an NR system, but the meaning thereof can be understood by those skilled in the art. The technical solutions described in the embodiments of the disclosure may be applied to a 5G NR system, or may be applied to a future evolved system of the 5G NR system. In embodiments of the disclosure, “terminal device” and “UE” usually represent the same meaning, and the two can be used in a mixed manner, but the meaning thereof can be understood by those skilled in the art.

Before introducing the technical solutions of the disclosure, some background technical knowledge involved in the disclosure is first introduced and explained. The related technologies below as an optional solution may be arbitrarily combined with the technical solutions of embodiments of the disclosure, and any combination thereof may belong to the scope of protection of embodiments of the disclosure. The embodiments of the disclosure include at least part of the following.

### 1. SL Transmission

For SL transmission, two transmission modes, i.e., mode A and mode B, are defined in 3rd generation partnership project (3GPP).

Mode A: an access network device allocates a transmission resource(s) to a terminal device. The terminal device performs communication data transmission on SL according to a resource(s) allocated by the access network device. The access network device may allocate to the terminal device a transmission resource(s) for single transmission or a transmission resource(s) for semi-static transmission.

Mode B: the terminal device autonomously selects a transmission resource(s) from a resource pool by itself to perform communication data transmission. Specifically, the terminal device may select a transmission resource(s) from a resource pool through sensing or random selection

The following mainly introduces a manner in which a terminal device autonomously performs resource selection for SL communication in an NR V2X system, i.e., mode B.

### 2. Physical Layer Structure in NR V2X

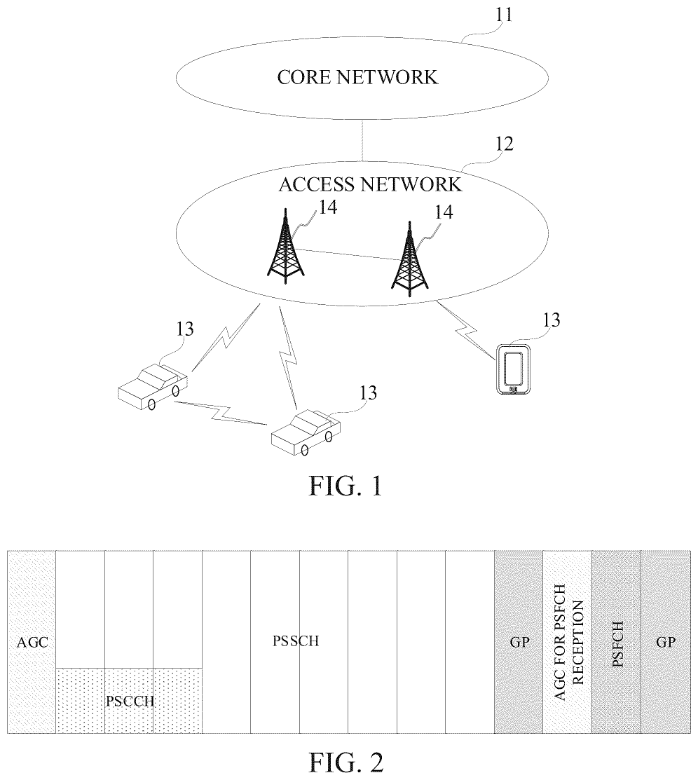

A physical layer structure for SL communication in the NR V2X system is illustrated in FIG. 2. In a slot illustrated in FIG. 2, a first symbol is an automatic gain control (AGC) symbol. In the case where an SL UE is to perform reception in the AGC symbol, the SL UE may adjust received power to be suitable for demodulation. In the case where the SL UE performs transmission in the AGC symbol, the SL UE repeats in the AGC symbol content to be transmitted in a symbol next to the AGC symbol. In FIG. 2, a physical sidelink control channel (PSCCH) is used to carry first sidelink control information (SCI), and a physical sidelink shared channel (PSSCH) is used to carry data and second SCI. The PSCCH and the PSSCH are transmitted in the same slot. The first SCI and the second SCI may be two SCI, where the first SCI may have a function different from that of the second SCI. For example, the first SCI is carried in the PSCCH and mainly contains a resource sensing-related field(s), which facilitates other terminal devices to perform resource exclusion and resource selection after the other terminal devices decode the PSCCH. Besides that the PSSCH carries data, the PSSCH also carries the second SCI, where the second SCI mainly contains a data demodulation-related field(s), which facilitates other terminal devices to demodulate the data in the PSSCH. In a certain slot, there may also be a PSFCH symbol, and the PSFCH symbol is used to feed back HARQ information. Depending on resource pool configuration, one PSFCH symbol may be configured every 1, 2, or 4 slots. In the case where there is no PSFCH symbol in a certain slot, as an example, a gap symbol between a PSSCH and a PSFCH, an AGC symbol for PSFCH reception, and a PSFCH symbol as illustrated in FIG. 2 are all used to carry a PSSCH. In general, the last symbol in a slot is a guard period (GP) symbol, i.e., a gap symbol. In other words, a symbol next to the last symbol that carries a PSSCH or a PSFCH is a GP symbol. The SL UE performs transmission-reception switching in a GP symbol and does not perform transmission in the GP symbol. In the case where there is a PSFCH resource in a slot, there also is a GP symbol between a PSSCH symbol and a PSFCH symbol due to the following. The UE may perform PSSCH transmission and perform PSFCH reception, and thus a GP symbol is needed for the UE to perform transmission-reception switching.

### 3. Resource Reservation in NR V2X

In an NR V2X system, in mode B, the terminal device autonomously selects a transmission resource(s) to perform data transmission. Resource reservation is a prerequisite for resource selection.

Resource reservation means that the terminal device transmits first SCI over a PSCCH to reserve a resource(s) for future use. In the NR V2X system, resource reservation for a single TB is supported and resource reservation for TBs also is supported.

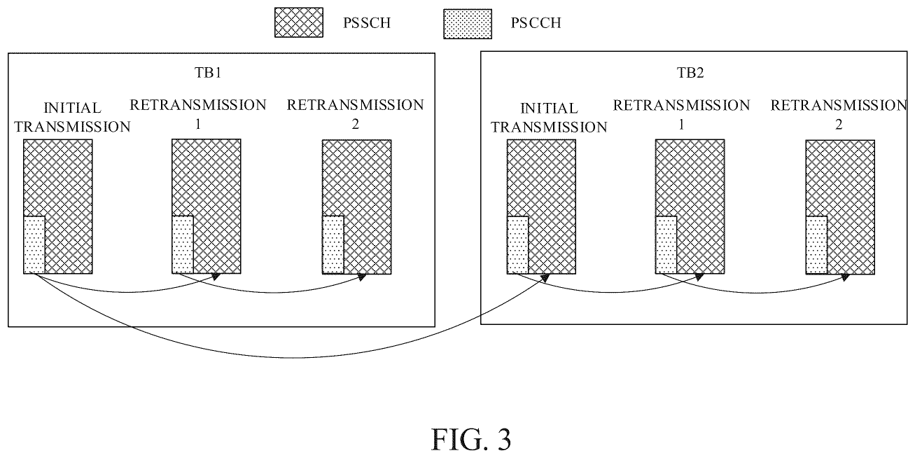

As illustrated in FIG. 3, the terminal device transmits the first SCI to indicate, via a “time resource assignment” field and a “frequency resource assignment” field in the first SCI, N time-frequency resources for a current TB (including a resource(s) used for the current transmission). N≤Nmax, and in NR V2X, Nmax is equal to 2 or 3. The N time-frequency resources indicated may be distributed in W slots. In NR V2X, W is equal to 32. For example, for TB1 illustrated in FIG. 3, besides the terminal device performs initial transmission of data over a PSSCH, the terminal device transmits the first SCI over the PSCCH to indicate, via the “time resource assignment” field and the “frequency resource assignment” field, a position of a time-frequency resource for the initial transmission and a position of a time-frequency resource for retransmission 1 (i.e., in this case, N=2), i.e., the terminal device reserves the time-frequency resource for the retransmission 1. Moreover, the initial transmission and the retransmission 1 are distributed in 32 slots in the time domain. Similarly, for TB1 illustrated in FIG. 3, the terminal device indicates, via the first SCI transmitted over the PSCCH for the retransmission 1, the position of the time-frequency resource for the retransmission 1 and a position of a time-frequency resource for retransmission 2. The retransmission 1 and the retransmission 2 are distributed in 32 slots in the time domain.

Meanwhile, the terminal device transmits the first SCI to perform resource reservation for TBs via a “resource reservation period” field in the first SCI. For example, in FIG. 3, in the case where the terminal device performs initial transmission of TB1, the terminal device transmits the first SCI to indicate a position of a time-frequency resource for the initial transmission of TB1 and a position of a time-frequency resource for retransmission 1 of TB1 via the “time resource assignment” field and the “frequency resource assignment” field in the first SCI. The position of the time-frequency resource for the initial transmission of TB1 and the position of the time-frequency resource for the retransmission 1 of TB1 are represented as {(t₁, f₁), (t₂, f₂)}, where t₁ represent a time-domain position of the resource for the initial transmission of TB1, t₂ represent a time-domain position of the resource for the retransmission 1, f₁ represent a frequency-domain position of the resource for the initial transmission of TB1, and f₂ represent a frequency-domain position of the resource for the retransmission 1. In the case where a value of the “resource reservation period” field in the first SCI is 100 ms, the SCI indicates time-frequency resources {(t₁+100, f₁), (t₂+100, f₂)}, where time-frequency resource (t₁+100, f₁) is used for initial transmission of TB2 and time-frequency resource (t₂+100, f₂) is used for retransmission 1 of TB2. Similarly, in the case where the terminal device performs the retransmission 1 of TB1, the terminal device transmits the first SCI to reserve a time-frequency resource for the retransmission 1 of TB2 and a time-frequency resource for retransmission 2 of TB2 via the “resource reservation period” field in the first SCI. In NR V2X, possible values of the “resource reservation period” field are 0, 1-99, 100, 200, 300, 400, 500, 600, 700, 800, 900, and 1000 ms, so that V2X is more flexible compared with LTE. However, only e values in these values are configured per resource pool, and the terminal device may determine, according to a used resource pool, a value possibly to be used. The e values in a resource pool configuration are recorded as a set of resource reservation periods M, exemplarily, e is less than or equal to 16.

In addition, reservation for TBs can be activated or de-activated in the unit of a resource pool through configuration by a network or pre-configuration. In the case where the first SCI contains the “resource reservation period” field, reservation for TBs is activated. In the case where the first SCI does not contain the “resource reservation period” field, reservation for TBs is deactivated. Generally, the value of the “resource reservation period” field, i.e., a resource reservation period, used by the terminal device remains unchanged before resource reselection is triggered, and each time the terminal device transmits the first SCI to activate reservation for TBs, the terminal device uses the “resource reservation period” field in the first SCI to reserve a resource(s) in the next period for transmission of another TB, thereby achieving periodically semi-persistent transmission.

In the case where the terminal device operates in mode B, the terminal device may obtain first SCI transmitted by another terminal device by sensing a PSCCH transmitted by the other terminal device, and thus the terminal device can know a resource(s) reserved by the other terminal device. During resource selection, the terminal device may exclude the resource(s) reserved by the other terminal device, thereby avoiding resource collision.

### 4. Manner for Resource Selection Through Sensing in NR V2X

In the NR V2X system, in mode B, the terminal device needs to autonomously perform resource selection.

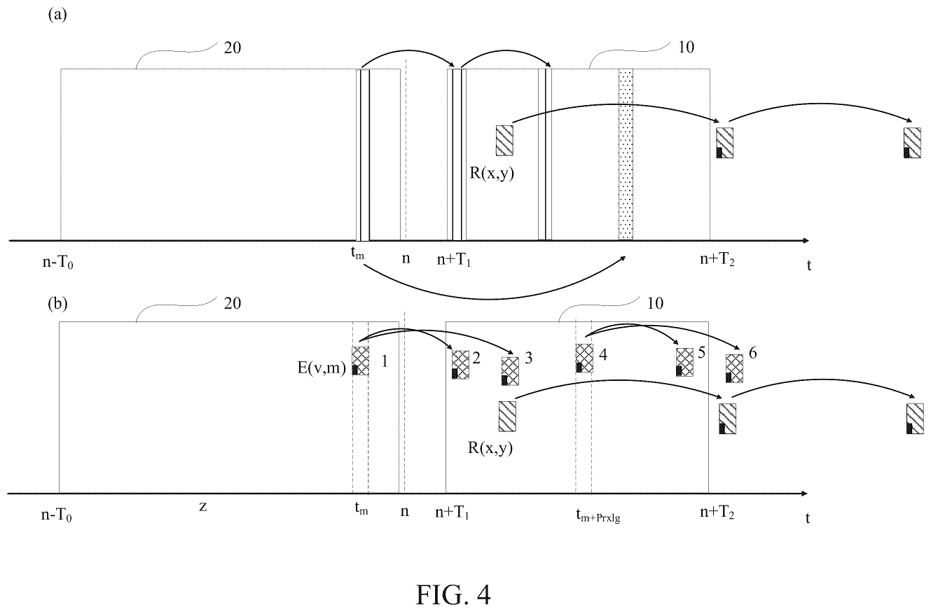

As illustrated in FIG. 4, in the case where the terminal device triggers resource selection or resource reselection in slot n or in the case where a higher layer triggers a physical layer to report a candidate resource set in slot n, a resource selection window 10 starts from n+T₁ and ends at n+T₂. 0<=T₁<=T_{proc,1}, where T_{proc,1} is 3, 5, 9, or 17 slots in the case where a subcarrier spacing is 15, 30, 60, or 120 kHz, respectively. T₂ₘᵢₙ<=T₂<=remaining packet delay budget, where a value set of T₂ₘᵢₙ is {1, 5, 10, 20}*24 slots, and μ=0, 1, 2, or 3 respectively corresponds to a subcarrier spacing of 15, 30, 60, or 120 kHz. The terminal device determines T₂ₘᵢₙ from the value set according to a priority class of data to be transmitted by the terminal device. For example, in the case where the subcarrier spacing is 15 kHz, the terminal device determines T₂ₘᵢₙ from a set {1, 5, 10, 20} according to the priority class of the data to be transmitted by the terminal device. In the case where T₂ₘᵢₙ is greater than or equal to the remaining packet delay budget, T₂ is equal to the remaining packet delay budget. The remaining packet delay budget is a difference between a time corresponding to a data latency requirement and the current time. For example, in the case where a packet arriving in slot n has a latency requirement of 50 ms and assuming that a slot is 1 ms, the remaining packet delay budget is 50 ms in the case where the current time is slot n, or the remaining packet delay budget is 30 ms in the case where the current time is slot n+20.

The terminal device performs resource sensing within a time interval from n-T₀ to n-T_{proc,0} (excluding n-T_{proc,0}), where a value of T₀ is 100 ms or 1100 ms, and T_{proc,0} is 1, 1, 2, or 4 slots in the case where the subcarrier spacing is 15, 30, 60, or 120 kHz, respectively. Optionally, the terminal device performs resource sensing in a slot belonging to a resource pool used by the terminal device within a resource sensing window. Optionally, the terminal device may sense in each slot (except for a slot(s) in which its own transmissions occur) first SCI transmitted by another terminal device, and after resource selection or resource reselection is triggered in slot n, the terminal device uses a result of resource sensing within the time interval from n-T₀ to n-T_{proc,0}.

Step 1: the terminal device determines all available resources belonging to the resource pool used by the terminal device within the resource selection window 10 as resource set A. Any one resource in set A is represented as R(x,y), where x indicates a time-domain position of a resource, and y indicates a frequency-domain position of a resource. The initial number of resources in set A is denoted by Mₜₒₜₐₗ. The terminal device performs resource exclusion on resource set A according to a slot(s) not sensed within a resource sensing window 20 (step 1-1) and/or a result of resource sensing within the resource sensing window 20 (step 1-2). The terminal device determines whether resource R(x,y) or a series of periodic resources corresponding to resource R(x,y) overlaps a slot determined according to the slot(s) not sensed at step 1-1 or a resource determined according to first SCI sensed at step 1-2. In the case where the terminal device determines that resource R(x,y) or the series of periodic resources corresponding to resource R(x,y) overlaps the slot determined according to the slot(s) not sensed at step 1-1 or the resource determined according to the first SCI sensed at step 1-2, the terminal device excludes resource R(x,y) from resource set A.

Step 1-1: in the case where the terminal device transmits data in slot tₘ within the resource sensing window 20 without sensing, the terminal device may determine corresponding Q slot(s) according to slot tₘ and each allowed resource reservation period in the resource pool used by the terminal device and with each allowed resource reservation period as an interval. In the case where the Q slot(s) overlaps resource R(x,y) or a series of periodic resources corresponding to resource R(x,y), resource R(x,y) is excluded from resource set A. Q=1 or Q=┌Tscal/Prx┐ (┌┐ represents rounding up). Tscal is set to selection window size T₂ converted to units of msec. Prx represents one of allowed resource reservation periods in the resource pool used by the terminal device. Optionally, the series of periodic resources corresponding to resource R(x,y) is represented as R(x,y+j*Ptxlg), where j=0, 1, 2, . . . , Cresel-1. Cresel is related to a random count value generated by the terminal device, and Ptxlg represents the number of logical slots converted from Ptx. Ptx represents a resource reservation period for the terminal device. For example, FIG. 4(a) illustrates 3 periodic resources corresponding to resource R(x,y) (including R(x,y)) in the case where Cresel is 3. Optionally, Q=┌Tscal/Prx┐ in the case where Prx<Tscal and/or n1-m is less than or equal to Prxlg. Prxlg represents the number of logical slots converted from Prx. Optionally, Q=1. tₙ₁ is n if slot n belongs to the resource pool used by the terminal device, otherwise, tₙ₁ is the first slot after slot n belonging to the resource pool used by the terminal device. Optionally, the Q slot(s) is represented as t_{m+q*Prxlg}, where q is 1, 2, . . . , Q.

Optionally, (t₁, t₂, . . . , t_{N}) denotes slots which belong to the resource pool for the terminal device. That is, tₘ, tₙ₁, and t_{m+q*Prxlg} each denotes a slot which belongs to the resource pool, and a slot corresponding to R(x,y+j*Ptxlg) also is a slot which belongs to the resource pool.

For example, as illustrated in FIG. 4(a), the terminal device does not perform sensing in slot tₘ, and performs resource exclusion sequentially according to each resource reservation period in the set of resource reservation periods M in configuration of the resource pool used by the terminal device. For resource reservation period 1 in the set of resource reservation periods M, assuming that a value of Q is calculated as 2, with resource reservation period 1 as an interval, as illustrated in FIG. 4(a), corresponding Q slots are 2 slots identified with horizontal line shading and mapped from slot tₘ. For resource reservation period 2, with resource reservation period 2 as an interval, assuming that the value of Q is calculated as 1, as illustrated in FIG. 4(a), corresponding Q slot is 1 slot identified with dotted shading and mapped from slot tₘ.

The terminal device may determine whether Q slot(s) corresponding to each reservation period overlaps resource R(x,y) or a series of periodic resources corresponding to resource R(x,y). In the case where the terminal device determines that the Q slot(s) corresponding to each reservation period overlaps resource R(x,y) or the series of periodic resources corresponding to resource R(x,y), the terminal device excludes resource R(x,y) from the resource set A.

Optionally, in the case where reservation for TBs is de-activated in the unit of the resource pool used by the terminal device, the terminal device may not perform step 1-1.

Optionally, after step 1-1 is performed, if the number of resources remaining in the resource set A is smaller than Mₜₒₜₐₗ*X, the resource set A is initialized to a set of all available resources belonging to the resource pool used by the terminal device within the resource selection window 10 and then step 1-2 is performed.

Step 1-2: in the case where first SCI transmitted over a PSCCH is sensed by the terminal device in slot tₘ within the resource sensing window 20, the terminal device measures sidelink reference signal received power (SL-RSRP) of the PSCCH or SL-RSRP of a PSSCH scheduled by the PSCCH (i.e., SL-RSRP of the PSSCH transmitted in the same slot as the PSCCH).

In the case where SL-RSRP obtained through measurement exceeds an SL-RSRP threshold and reservation for TBs is activated in the unit of the resource pool used by the terminal device, the terminal device may determine corresponding Q slot(s) according to slot tₘ and a resource reservation period carried in the first SCI sensed and with the resource reservation period as an interval. Assuming that the terminal device also receives in each of the Q slot(s) first SCI carrying the same content as the first SCI sensed, the terminal device determines whether a resource indicated via a “time resource assignment” field and a “frequency resource assignment” field in the first SCI received in slot tₘ overlaps resource R(x,y) or a series of periodic resources corresponding to resource R(x,y), and whether a resource indicated via a “time resource assignment” field and a “frequency resource assignment” field in each of Q first SCI hypothetically received overlaps resource R(x,y) or a series of periodic resources corresponding to resource R(x,y). In the case where the terminal device determines that the resource indicated via the “time resource assignment” field and the “frequency resource assignment” field in the first SCI received in slot tₘ overlaps resource R(x,y) or the series of periodic resources corresponding to resource R(x,y) and the resource indicated via the “time resource assignment” field and the “frequency resource assignment” field in each of the Q first SCI hypothetically received overlaps resource R(x,y) or the series of periodic resources corresponding to resource R(x,y), the terminal device excludes resource R(x,y) from set A. Q=1 or Q-┌Tscal/Prx┐ (┌┐ represents rounding up). Tscal is set to selection window size T₂ converted to units of msec. Prx represents the resource reservation period carried in the first SCI sensed. Optionally, the series of periodic resources corresponding to resource R(x,y) is represented as R(x,y+j*Ptxlg), where j=0, 1, 2, . . . , Cresel-1. Cresel is related to a random count value generated by the terminal device, and Ptxlg represents the number of logical slots converted from Ptx. Ptx represents a resource reservation period for the terminal device. For example, FIG. 4(b) illustrates 3 periodic resources corresponding to resource R(x,y) (including R(x,y)) in the case where Cresel is 3. Optionally, Q=┌Tscal/Prx┐ in the case where when Prx<Tscal and/or n1-m is less than or equal to Prxlg. Prxlg represents the number of logical slots converted from Prx. tₙ₁ is n if slot n belongs to the resource pool used by the terminal device, otherwise, tₙ₁ is the first slot after slot n belonging to the resource pool used by the terminal device. Optionally, the Q slot(s) is represented as t_{m+q*Prxlg}, where q is 1, 2, . . . , Q.

Optionally, (t₁, t₂, . . . , t_{N}) denotes slots which belong to the resource pool for the terminal device. That is, tₘ, tₙ₁, and t_{m+q*Prxlg} each denotes a slot which belongs to the resource pool, and a slot corresponding to R(x,y+j*Ptxlg) also is a slot which belongs to the resource pool.

For example, as illustrated in FIG. 4(b), in the case where reservation for TBs is activated in the unit of the resource pool used by the terminal device and in the case where first SCI in a PSCCH is sensed by the terminal device through resource E(v,m) in slot tₘ, where a resource reservation period in the first SCI is represented as Prx, and assuming that the value of Q is calculated as 1, it is assumed that the terminal device also receives in slot t_{m+Prxlg} first SCI carrying the same content as the first SCI sensed. The terminal device determines whether resources 1, 2, and 3 indicated via a “time resource assignment” field and a “frequency resource assignment” field in the first SCI received in slot tₘ overlap resource R(x,y) or a series of periodic resources corresponding to resource R(x,y) and whether resources 4, 5, and 6 indicated via a “time resource assignment” field and a “frequency resource assignment” field in the first SCI hypothetically received in slot t_{m+Prxlg} overlap resource R(x,y) or a series of periodic resources corresponding to resource R(x,y). In the case where the terminal device determines that resources 1, 2, 3, 4, 5, and 6 overlap resource R(x,y) or the series of periodic resources corresponding to resource R(x,y) and an RSRP condition is satisfied, the terminal device excludes resource R(x,y) from resource set A.

In the case where SL-RSRP obtained by the terminal device through measurement exceeds the SL-RSRP threshold and reservation for TBs is de-activated in the unit of the resource pool used by the terminal device, the terminal device only determines whether the resource indicated via the “time resource assignment” field and the “frequency resource assignment” field in the first SCI received in slot tₘ overlaps resource R(x,y) or a series of resources corresponding to resource R(x,y). In the case where the terminal device determines that the resource indicated via the “time resource assignment” field and the “frequency resource assignment” field in the first SCI received in slot tₘ overlaps resource R(x,y) or the series of resources corresponding to resource R(x,y), the terminal device excludes resource R(x,y) from resource set A.

For example, as illustrated FIG. 4(b), in the case where reservation for TBs is de-activated in the unit of the resource pool used by the terminal device and in the case where the first SCI in the PSCCH is sensed by the terminal device through resource E(v,m) in slot tₘ, the terminal device determines whether resources 1, 2, and 3 indicated via the “time resource assignment” field and the “frequency resource assignment” field in the first SCI overlap resource R(x,y) or a series of periodic resources corresponding to resource R(x,y). In the case where the terminal device determines that resources 1, 2, and 3 indicated via the “time resource assignment” field and the “frequency resource assignment” field in the first SCI overlap resource R(x,y) or the series of periodic resources corresponding to resource R(x,y) and the RSRP condition is satisfied, the terminal device excludes resource R(x,y) from resource set A.

If the number of resources remaining in resource set A subject to resource exclusion is smaller than Mₜₒₜₐₗ*X, the SL-RSRP threshold is increased by 3 dB and step 1 is repeated. The physical layer reports to the higher layer resource set A subject to resource exclusion as a candidate resource set.

Step 2: the higher layer randomly selects a resource(s) for data transmission from the candidate resource set reported. That is, the terminal device randomly selects a resource(s) for data transmission from the candidate resource set.

The following is required to be noted.

(1) The RSRP threshold above is determined according to priority class P1 carried in a PSCCH sensed by the terminal device and priority class P2 of data to be transmitted by the terminal device. The configuration of the resource pool used by the terminal device contains an SL-RSRP threshold table, where the SL-RSRP threshold table contains SL-RSRP thresholds respectively corresponding to all priority class combinations. The configuration of the resource pool may be configured by a network or pre-configured.

For example, as illustrated in Table 1, assuming that an optional value of priority class P1 ranges from 0 to 7 and an optional value of priority class P2 ranges from 0 to 7, an SL-RSRP threshold corresponding to each of different priority class combinations is represented as γᵢⱼ, where i in γᵢⱼ represents a value of priority class P1 and j represents a value of priority class P2.

TABLE 1
SL-RSRP threshold Table

P2

| P1 | 0 | 1 | 2 | 3 | 4 | 5 | 6 | 7 |
|---|---|---|---|---|---|---|---|---|
| 0 | γ₀₀ | γ₀₁ | γ₀₂ | γ₀₃ | γ₀₄ | γ₀₅ | γ₀₆ | γ₀₇ |
| 1 | γ₁₀ | γ₁₁ | γ₁₂ | γ₁₃ | γ₁₄ | γ₁₅ | γ₁₆ | γ₁₇ |
| 2 | γ₂₀ | γ₂₁ | γ₂₂ | γ₂₃ | γ₂₄ | γ₂₅ | γ₂₆ | γ₂₇ |
| 3 | γ₃₀ | γ₃₁ | γ₃₂ | γ₃₃ | γ₃₄ | γ₃₅ | γ₃₆ | γ₃₇ |
| 4 | γ₄₀ | γ₄₁ | γ₄₂ | γ₄₃ | γ₄₄ | γ₄₅ | γ₄₆ | γ₄₇ |
| 5 | γ₅₀ | γ₅₁ | γ₅₂ | γ₅₃ | γ₅₄ | γ₅₅ | γ₅₆ | γ₅₇ |
| 6 | γ₆₀ | γ₆₁ | γ₆₂ | γ₆₃ | γ₆₄ | γ₆₅ | γ₆₆ | γ₆₇ |
| 7 | γ₇₀ | γ₇₁ | γ₇₂ | γ₇₃ | γ₇₄ | γ₇₅ | γ₇₆ | γ₇₇ |

In the case where a PSCCH transmitted by another terminal device is sensed by the terminal device, the terminal device obtains priority class P1 in first SCI transmitted over the PSCCH and priority class P2 of data to be transmitted by the terminal device, and then determines an SL-RSRP threshold by looking up Table 1.

(2) Whether the terminal device compares PSCCH-RSRP obtained through measurement or RSRP of the PSSCH scheduled by the PSCCH (i.e., PSSCH-RSRP) with the SL-RSRP threshold depends on the resource pool configuration of the resource pool used by the terminal device. The configuration of the resource pool may be configured by a network or pre-configured.

(3) Possible values of X are {20%, 35%, 50%}. The configuration of the resource pool used by the terminal device contains a correspondence between priority classes and the above possible values, and the terminal device determines the value of X according to a priority class of data to be transmitted by the terminal device and the correspondence. The configuration of the resource pool may be configured by a network or pre-configured.

### (4) Convert a Resource Reservation Period Into Logical Slots

As mentioned above, the terminal device transmits first SCI to indicate a time-frequency resource and reserve a resource(s) for future use. In the case where the terminal device performs sensing to select a resource(s), the terminal device may decode first SCI transmitted by other terminal devices to obtain a resource(s) reserved by other terminal devices, and then the terminal device may exclude a corresponding resource(s) during resource selection, thereby avoiding resource collision. In the case where the terminal device performs resource exclusion during resource selection, the terminal device may covert a physical time (e.g., 100 ms) indicated via a “resource reservation period” field in the decoded first SCI into the corresponding number of logical slots, and then performs resource exclusion according to the number of the logical slots as follows:

$${P}_{rsvp}^{′} = ⌈ \frac{T {′}_{max}}{10240 ms} \times {P}_{rsvp} ⌉ .$$

In the above formula, Prsvp represents a resource reservation period, e.g., Prsvp represents a resource reservation period indicated via the “resource reservation period” field in the first SCI sensed by the terminal device, or an allowed resource reservation period in a resource pool, or a resource reservation period for the terminal device. P′rsvp represents the corresponding number of the logical slots calculated. T′max represents the number of slots belonging to a resource pool for the terminal device in a system frame number (SFN) period or 10240 ms or belonging to a transmission resource pool in an SFN period or 10240 ms.

The above introduces an SL communication mode in NR-V2X, i.e., the terminal device autonomously selects a transmission resource(s) through resource sensing and autonomously transmits data on SL. The SL communication mode can also be applied to various SL communications such as direct communication between handheld terminals and direct communication between pedestrians and vehicles.

### 5. Carrier Aggregation (CA) in SL

SL CA is supported in LTE-V2X, and thus a terminal device can perform data transmission in parallel on one or more carriers, thereby improving throughput of an SL transmission system.

In a CA scenario in the LTE-V2X, in mode B, the terminal device also needs to perform resource exclusion according to resource sensing and/or a subframe(s) not sensed to obtain a candidate resource set and select a resource(s) from the candidate resource set to perform data transmission. Under some conditions, after the candidate resource set is obtained and before the candidate resource set is reported to the higher layer, it is necessary to further exclude from the candidate resource set a candidate resource(s) unavailable for transmission by the terminal device.

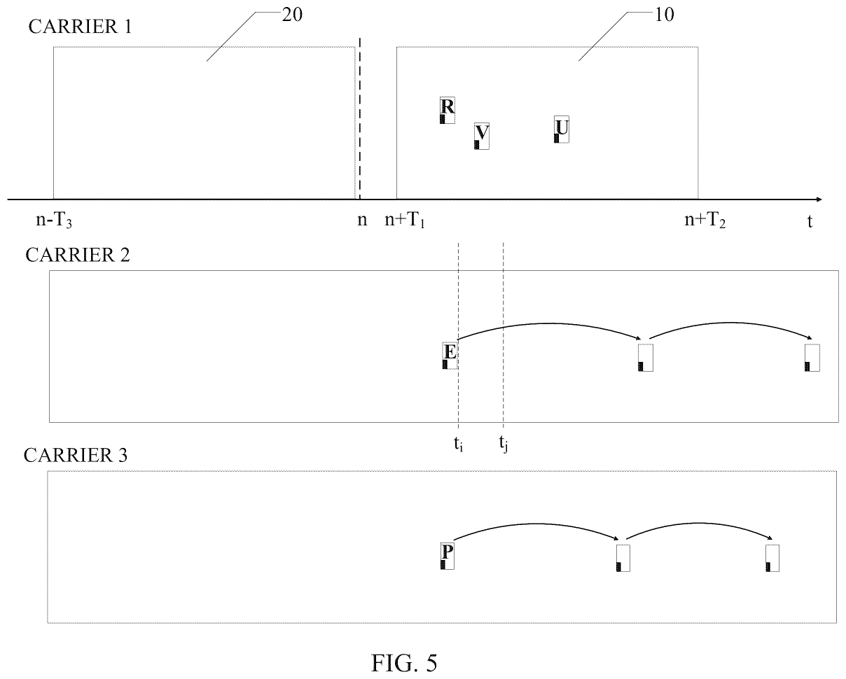

For example, in FIG. 5, the terminal device triggers resource selection or resource reselection in subframe n and selects a resource(s) on carrier 1. The terminal device determines a resource selection window 10 and a resource sensing window 20 and performs resource exclusion to obtain a candidate resource set. The candidate resource set contains resource R, resource V, and resource U. Under the following conditions, the terminal device further excludes from the candidate resource set a candidate resource(s) unavailable for transmission.

### Condition 1: the Number of Carriers Simultaneous Transmission on Which is Supported by the Terminal Device

For example, in the case where the terminal device only supports simultaneous transmission on two carriers, and in the case where the terminal device has already selected resource E on carrier 2 and resource P on carrier 3 and both resource E and resource P overlap resource R in the time domain, the terminal device needs to exclude resource R from the candidate resource set. A cause for the above is that if the terminal device selects resource R, the terminal device needs to simultaneously perform transmission on three carriers, which exceeds a capability of the terminal device.

### Condition 2: a Limitation in CA or Carrier Combination

For example, the terminal device does not support aggregation or combination of carrier 1 and carrier 2, i.e., the terminal device cannot perform transmission on carrier 1 while the terminal device performs transmission on carrier 2. In the case where the terminal device has selected resource E on carrier 2 and resource E overlaps resource R in the time domain, the terminal device needs to exclude resource R from the candidate resource set.

### Condition 3: Interruption Due to Radio Frequency (RF) Retuning

For example, the terminal device does not support aggregation or combination of carrier 1 and carrier 2, i.e., the terminal device cannot perform transmission on carrier 1 while the terminal device performs transmission on carrier 2. In the case where the terminal device needs to perform transmission on carrier 1 after performing transmission on carrier 2, the terminal device needs to retune device hardware or RF to perform transmission on carrier 1. During retuning, the terminal device cannot perform transmission. For example, after the terminal device performs transmission through resource E on carrier 2, the terminal device needs to perform RF retuning within a time interval from subframe tᵢ to subframe tⱼ, and if resource V overlaps the time interval from subframe tᵢ to subframe tⱼ in the time domain, the terminal device needs to exclude resource V from the candidate resource set.

For another example, the terminal device supports two sets of RFs, which may also be referred to as two RF chains. RF chain 1 is used for transmission on carrier 1 and carrier 2, and RF chain 2 is used for transmission on carrier 3. Therefore, the terminal device needs to tune RF chain 2 to support transmission on two carriers. Similarly, after the terminal device performs transmission through resource E on carrier 2, in the case where a time interval in which the terminal device performs RF retuning overlaps resource V in the time domain, the terminal device excludes resource V from the candidate resource set.

### 6. HARQ Feedback and PSFCH Resource

HARQ feedback: for each transmission by a transmitting terminal, a receiving terminal may feed back acknowledgement (ACK) or negative acknowledgement (NACK) to the transmitting terminal according to whether reception succeeds. ACK indicates that reception succeeds, and NACK indicates that reception fails. The receiving terminal feeds back HARQ to the transmitting terminal through a PSFCH.

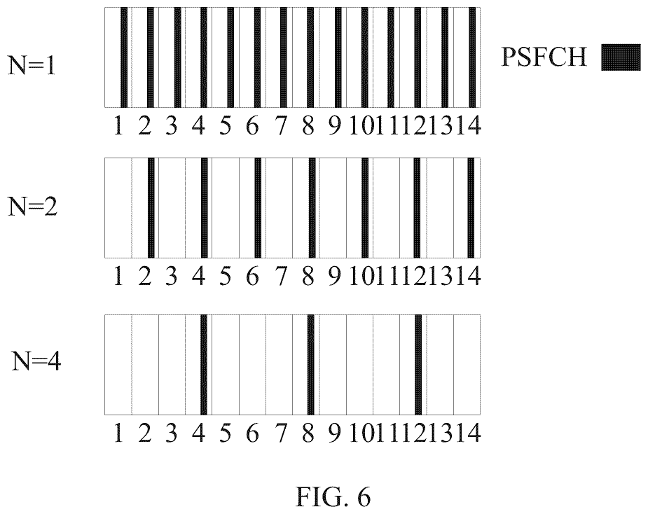

PSFCH resources are configured for each resource pool. In NR-V2X, there are three configurations: N=1, N=2, and N=4. As illustrated in FIG. 6, N=1 represents that a PSFCH resource is configured in each slot in a resource pool, N=2 represents that a PSFCH resource is configured every 2 slots in a resource pool, and N=4 represents that a PSFCH resource is configured every 4 slots in a resource pool. In NR-V2X, a PSFCH resource is configured in a penultimate symbol among symbols available for SL transmission in a slot (it may be noted that an example in FIG. 6 illustrates that a PSFCH resource occupies the entire frequency domain, alternatively, only part of physical resource blocks (PRBs) may be configured as a PSFCH resource). In the case where UE 1 transmits data to UE 2 in slot t, in response to this data transmission, UE 2 feeds back HARQ to UE 1 in slot t+a, where a is greater than or equal to k, slot t+a contains a PSFCH resource, and k is 2 or 3 slots in NR-V2X. For example, in FIG. 6, assuming N=4 and k=2 and in the case where UE 1 transmits data to UE 2 in slot 1, t+a is slot 4, and thus UE 2 feeds back HARQ to UE 1 in slot 4. In the case where UE 1 transmits data to UE 2 in slot 3, t+a is slot 8, and thus UE 2 feeds back HARQ to UE 1 in slot 8. Therefore, a time-domain position of a PSFCH resource on which feedback is to be performed is determined according to a time-domain position of a corresponding PSSCH. A frequency-domain position and a code-domain resource of the PSFCH resource, for example, a code-domain sequence corresponding to a certain PRB to-be-used, is determined according to at least one of: a slot for the corresponding PSSCH, a sub-channel for the corresponding PSSCH, or a source identifier (ID) for the corresponding PSSCH. The ultimately determined PSFCH resource refers to a code-domain sequence corresponding to a certain PRB that is in a PSFCH symbol in a certain slot configured with a PSFCH resource.

### 7. Resource Pool

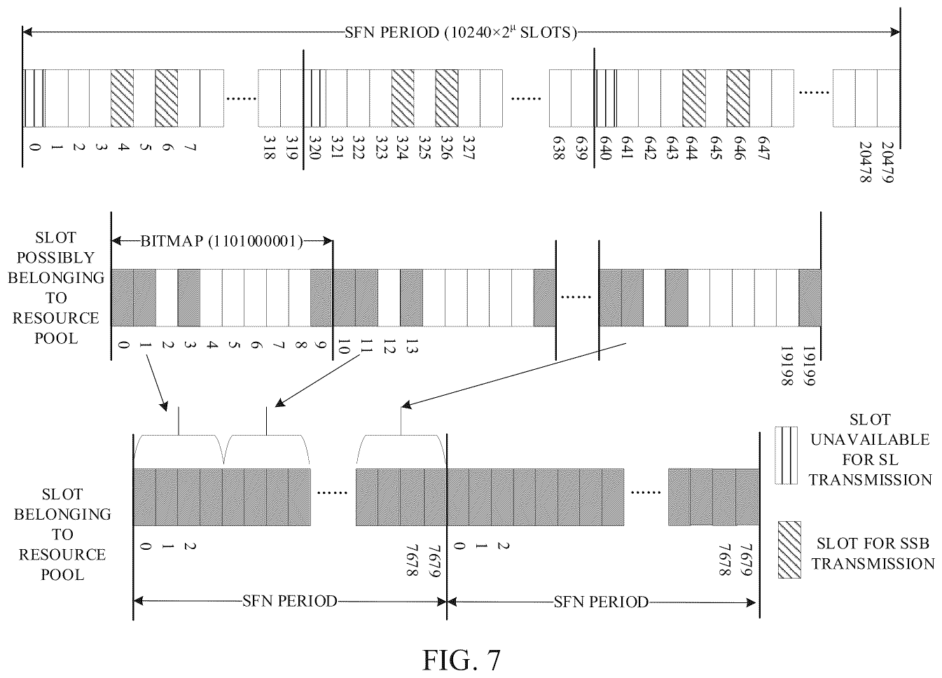

In an NR-V2X system, the terminal device determines, via a bitmap configured by a network or pre-configured, slots belonging to a resource pool. First, 10240×2^{μ} slots are contained in an SFN period or a direct frame number (DFN) period, where μ is related to a subcarrier spacing. As illustrated in FIG. 7, in the case of μ=1, i.e., a subcarrier spacing is 30 kHz, 20480 slots are contained in an SFN period. First, slots for synchronization signal block (SSB) transmission and slots unavailable for SL transmission are excluded from all slots in the SFN period. Specifically, the slot for SSB transmission is determined according to a synchronization-related configuration parameter(s), such as a period for SSB transmission and the number of resources for SSB transmission configured in the period. The slot unavailable for SL transmission is determined according to sl-StartSymbol-r16, sl-LengthSymbols-r16, and uplink-downlink configuration. In a slot, in the case where one of sl-LengthSymbols-r16 contiguous orthogonal frequency division multiplexing (OFDM) symbols starting from a symbol corresponding to sl-StartSymbol-r16 is not configured as an uplink symbol, the slot is unavailable for SL transmission. Optionally, in the case where the terminal device operates on an exclusive carrier, such as an intelligent transportation system (ITS) carrier, the slots unavailable for SL transmission may not be excluded. In the case where the number of remaining slots after exclusion cannot be divided exactly by a length of the bitmap configured, it is necessary to further exclude some reserved slots, so that the number of remaining slots can be divided exactly by the length of the bitmap. For example, in FIG. 7, the length of the bitmap configured is 10, and after the slots for SSB transmission and the slots unavailable for SL transmission are excluded from the SFN period, there are 19200 remaining slots that can be divided exactly by the length of the bitmap, so that there is no need to exclude reserved slots.

The remaining slots after exclusion are renumbered and referred to as slots possibly belonging to the resource pool. The slots possibly belonging to the resource pool are logically contiguous but physically non-contiguous. Since the total number of the slots possibly belonging to the resource pool can be divided exactly by the length of the bitmap, which slots belonging to the resource pool configured can be determined according to the bitmap configured. For example, in FIG. 7, assuming that the bitmap configured is (1101000001)₂, slots identified with shading in the slots possibly belonging to the resource pool in FIG. 7 are slots belonging to the resource pool. Similarly, the slots belonging to the resource pool are logically contiguous but physically non-contiguous.

Current standard does not discuss a scheme for resource selection in a CA scenario in NR-V2X. In the CA scenario, a receiving terminal can independently perform HARQ feedback over a PSFCH resource on each carrier, or the receiving terminal can perform HARQ feedback only over a PSFCH resource on a certain carrier.

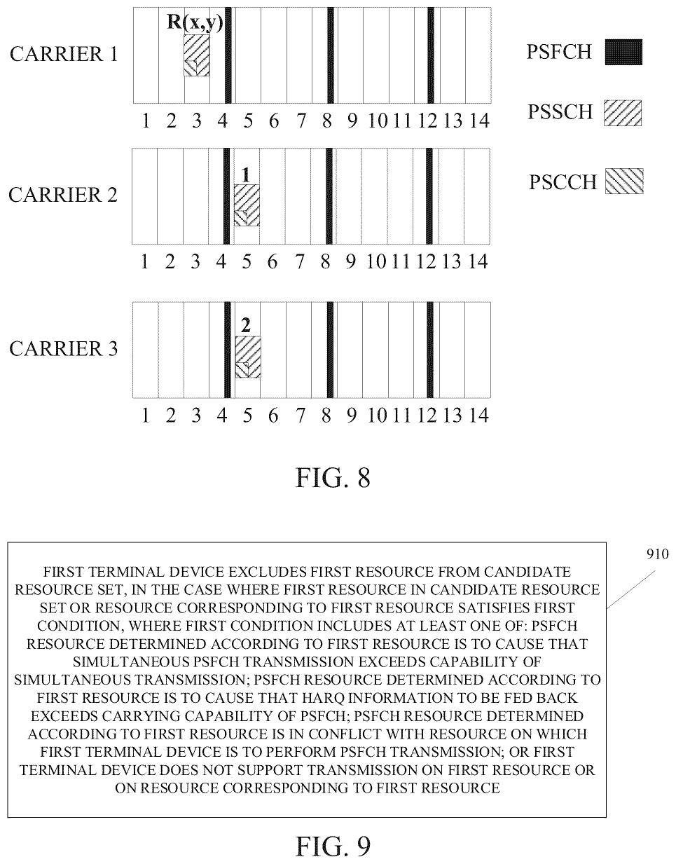

For example, in FIG. 8, UE 1 performs PSSCH transmission on carriers 1, 2, and 3, and the receiving terminal may perform feedback over a PSFCH resource on carrier 1, a PSFCH resource on carrier 2, and a PSFCH resource on carrier 3, or the receiving terminal may perform feedback over a PSFCH resource on only one (e.g., carrier 1) of the carriers.

In the above cases of independent feedback, assuming that UE 1 has already selected resource 1 on carrier 2 and resource 2 on carrier 3, according to a mapping relationship between PSSCH resources and PSFCH resources, a PSFCH resource corresponding to resource 1 is located in slot 8 on carrier 2, and a PSFCH resource corresponding to resource 2 is located in slot 8 on carrier 3. In the case where UE 1 performs resource selection on carrier 1, for resource R(x,y) in the candidate resource set, a corresponding PSFCH resource for feedback determined according to resource R(x,y) also is located in slot 8. Therefore, in the case where UE 1 selects R(x,y), it may result in that the receiving terminal needs to simultaneously perform PSFCH feedback on three carriers, and in this case, if a capability of the receiving terminal only supports PSFCH transmission on two carriers, it may result in that the receiving terminal has to abandon some PSFCH transmission. Therefore, to solve this problem, a solution for excluding candidate resource R(x,y) according to a transmission capability of a receiving terminal is proposed in the disclosure.

In the above cases that feedback is performed on only carrier 1, it may be necessary to introduce a long PSFCH format for carrier 1, where a PSFCH resource for feedback in the format may correspond to multiple-bit HARQ information to be fed back. Assuming that UE 1 has already selected resource 1 on carrier 2 and resource 2 on carrier 3, both a PSFCH resource corresponding to resource 1 and a PSFCH resource corresponding to resource 2 are PSFCH resource 1 in slot 8 on carrier 1. In the case where UE 1 performs resource selection on carrier 1, for resource R(x,y) in the candidate resource set, a corresponding PSFCH resource determined according to resource R(x,y) also is PSFCH resource 1 in slot 8 on carrier 1, and thus the receiving terminal needs to feed back 3-bit HARQ information over PSFCH resource 1. Assuming that PSFCH resource 1 can carry only 2-bit HARQ information to be fed back, it may result in that the receiving terminal has to abandon transmission of certain HARQ information. For this reason, the disclosure introduces a solution for excluding resource R(x,y) according to an HARQ-information carrying capability of a PSFCH resource or according to an HARQ-information carrying capability of a PSFCH format.

For another example, in FIG. 8, it is assumed that carriers 1, 2, and 3 are located in the same frequency band (or band). Assuming that UE 1 performs data reception through resource 1 on carrier 2, UE 1 determines to transmit PSFCH feedback in slot 8 on carrier 2 according to a correspondence. In the case where UE 1 performs resource selection on carrier 1, a PSFCH resource for feedback determined according to resource R(x,y) in the candidate resource set is located in slot 8 on carrier 1. Then UE 1 needs to perform PSFCH reception in slot 8 on carrier 1 and needs to perform PSFCH transmission in slot 8 on carrier 2. Since carrier 1 and carrier 2 are located in the same frequency band and transmission and reception cannot be performed simultaneously in the same slot, UE 1 needs to abandon PSFCH reception or PSFCH transmission. For this reason, the disclosure introduces a solution for excluding candidate resource R(x,y) according to a conflict between PSFCH reception and PSFCH transmission.

Refer to FIG. 9, which is a flow chart illustrating a method for resource exclusion provided in an embodiment of the disclosure. The method may be applied in a network architecture illustrated in FIG. 1, e.g. the method may be performed by a first terminal device. The method includes the following.

At 910, in the case where a first resource in a candidate resource set or a resource(s) corresponding to the first resource satisfies a first condition, the first terminal device excludes the first resource from the candidate resource set.

The first condition includes at least one of: a PSFCH resource determined according to the first resource is to cause that simultaneous PSFCH transmission exceeds a capability of simultaneous transmission; the PSFCH resource determined according to the first resource is to cause that HARQ information to be fed back exceeds a carrying capability of a PSFCH; the PSFCH resource determined according to the first resource is in conflict with a resource on which the first terminal device is to perform PSFCH transmission; or the first terminal device does not support transmission on the first resource or on the resource(s) corresponding to the first resource.

Optionally, the resource(s) corresponding to the first resource includes a periodic resource(s) corresponding to the first resource. For example, the first resource is represented as R(x,y), x indicates a time-domain position of the first resource, and y indicates a frequency-domain position of the first resource. The periodic resource(s) corresponding to the first resource is represented as R(x,y+j*Ptxlg), j is an integer belonging to [0,Cresel-1], Cresel is related to a random count value generated by the first terminal device, Ptxlg represents the number of logical slots converted from Ptx, and Ptx represents a resource reservation period for the first terminal device. For a manner in which Ptx is converted to Ptxlg, reference can be made to the introduction and explanation above, which is not repeated herein.

Optionally, the PSFCH resource determined according to the first resource includes: the PSFCH resource determined merely according to the first resource; or the PSFCH resource determined according to one or more of the periodic resource(s) corresponding to the first resource. In an example, the first resource is represented as R(x,y), and the periodic resources corresponding to the first resource include R(x,y), R(x,y+Ptxlg), and R(x,y+2*Ptxlg). The PSFCH resource determined merely according to the first resource refers to a PSFCH resource determined merely according to R(x,y). The PSFCH resource determined according to one or more of the periodic resource(s) corresponding to the first resource refers to a PSFCH resource determined according to one or more of R(x,y), R(x,y+Ptxlg), and R(x,y+2*Ptxlg), for example, a PSFCH resource determined according to R(x,y), a PSFCH resource determined according to R(x,y+Ptxlg), a PSFCH resource determined according to R(x,y+2*Ptxlg), a PSFCH resource determined according to R(x,y) and R(x,y+Ptxlg), a PSFCH resource determined according to R(x,y) and R(x,y+2*Ptxlg), a PSFCH resources determined according to R(x,y+Ptxlg) and R(x,y+2*Ptxlg), or a PSFCH resource determined according to R(x,y), R(x,y+Ptxlg), and R(x,y+2*Ptxlg).

Optionally, in the case where the PSFCH resource determined according to the first resource includes a PSFCH resource(s) determined according to X resource(s) of the periodic resource(s) corresponding to the first resource and in the case where X is greater than or equal to a first value, the first terminal device determines that the first condition is satisfied and excludes the first resource from the candidate resource set. The first value may be understood as a threshold, and the first value may be configured by a network, pre-configured, up to first terminal device implementation, or a preset value specified by a standard. Exemplarily, assuming that the first value is 3, whether a PSFCH resource determined according to each of the periodic resource(s) corresponding to the first resource is to cause that simultaneous PSFCH transmission exceeds the capability of simultaneous transmission is detected. In the case where there are three or more resources that are to cause that simultaneous PSFCH transmission exceeds the capability of simultaneous transmission, the first terminal device determines that the first condition is satisfied and excludes the first resource from the candidate resource set; otherwise, the first terminal device determines that the first condition is not satisfied and remains the first resource in the candidate resource set.

In some embodiments, whether to exclude the first resource from the candidate resource set is determined merely according to the first condition. That is, in the case where the first resource or the resource(s) corresponding to the first resource satisfies the first condition, the first terminal device excludes the first resource from the candidate resource set; otherwise, the first terminal device remains the first resource in the candidate resource set and does not exclude the first resource from the candidate resource set.

In some embodiments, whether to exclude the first resource from the candidate resource set is determined according to the first condition and a second condition. Optionally, in the case where the first resource or the resource(s) corresponding to the first resource satisfies the first condition and in the case where a priority class of data to be transmitted by the first terminal device on a carrier triggered for reporting of the candidate resource set satisfies a second condition, the first terminal device excludes the first resource from the candidate resource set; otherwise, the first terminal device remains the first resource in the candidate resource set and does not exclude the first resource. The carrier triggered for reporting of the candidate resource set may also be described as a carrier on which resource selection is performed, and carriers described in two ways are the same carrier.

Optionally, the second condition includes at least one of: the priority class of the data to be transmitted by the first terminal device on the carrier triggered for reporting of the candidate resource set is lower than or equal to a threshold; a relationship between the priority class of the data to be transmitted by the first terminal device on the carrier triggered for reporting of the candidate resource set and a priority class of data to be transmitted on a carrier from which a resource has been selected satisfies a third condition; or a relationship between the priority class of the data to be transmitted by the first terminal device on the carrier triggered for reporting of the candidate resource set and a priority class of PSFCH transmission performed by the first terminal device satisfies a fourth condition.

Optionally, the threshold is configured by the network, pre-configured, up to first terminal device implementation, or a preset value specified by a standard. Optionally, a priority class is expressed in a priority class value. In the case where a larger priority class value represents a higher priority class, the case that the priority class of the data to be transmitted is lower than or equal to the threshold means that a priority class value is less than or equal to the threshold. In the case where a smaller priority class value represents a higher priority class, the case that the priority class of the data to be transmitted is lower than or equal to the threshold means that the priority class value is greater than or equal to the threshold.

Optionally, the third condition may be that the priority class of the data to be transmitted by the first terminal device on the carrier through which the candidate resource set is triggered to be reported is lower than or equal to the priority class of the data transmitted on the carrier from which a resource has been selected. Optionally, the third condition may be that the priority class of the data to be transmitted by the first terminal device on the carrier triggered for reporting of the candidate resource set is lower than the priority class of the data transmitted on the carrier from which a resource has been selected and a difference between the two priority classes above is greater than or equal to a first target value. Optionally, the first target value is configured by the network, pre-configured, up to first terminal device implementation, or a preset value specified by a standard. Optionally, in the case where there is one carrier from which a resource has been selected, the priority class of the data transmitted on the carrier from which a resource has been selected is a priority class of data transmitted on this one carrier. Optionally, in the case where there are multiple carriers from which a resource has been selected, the priority class of the data transmitted on the carrier from which a resource has been selected may be a priority class of data transmitted on one target carrier among the multiple carriers. Exemplarily, the target carrier may be a carrier determined from the multiple carriers according to a certain rule or determined arbitrarily from the multiple carriers. For example, among the multiple carriers, the target carrier may be a carrier on which data of the lowest priority class is transmitted, or a carrier on which data of the highest priority class is transmitted, or a carrier on which data of any one priority class is transmitted, or a carrier randomly determined, etc., where a manner in which the target carrier is determined is not limited herein. In addition, the data transmitted on the carrier from which a resource has been selected may refer to data to be transmitted on the carrier from which a resource has been selected or data being transmitted on the carrier from which a resource has been selected, which is not limited herein. Optionally, a priority class is expressed in a priority class value. In the case where a larger priority class value represents a higher priority class, the case that the priority class of the data to be transmitted by the first terminal device on the carrier triggered for reporting of the candidate resource set is lower than or equal to the priority class of the data transmitted on the carrier from which a resource has been selected means that a priority class value of the data to be transmitted by the first terminal device on the carrier triggered for reporting of the candidate resource set is less than or equal to a priority class value of the data transmitted on the carrier from which a resource has been selected. In the case where a smaller priority class value represents a higher priority class, the case that the priority class of the data to be transmitted by the first terminal device on the carrier triggered for reporting of the candidate resource set is lower than or equal to the priority class of the data transmitted on the carrier from which a resource has been selected means that the priority class value of the data to be transmitted by the first terminal device on the carrier triggered for reporting of the candidate resource set is greater than or equal to the priority class value of the data transmitted on the carrier from which a resource has been selected.

Optionally, the fourth condition may be that the priority class of the data to be transmitted by the first terminal device on the carrier triggered for reporting of the candidate resource set is lower than or equal to the priority class of PSFCH transmission performed by the first terminal device. Optionally, the fourth condition may be that the priority class of the data to be transmitted by the first terminal device on the carrier triggered for reporting of the candidate resource set is lower than the priority class of PSFCH transmission performed by the first terminal device and a difference between the two priority classes above is greater than or equal to a second target value. Optionally, the second target value is configured by the network, pre-configured, up to first terminal device implementation, or a preset value specified by a standard. Optionally, the priority class of PSFCH transmission performed by the first terminal device is a priority class of data received by the first terminal device in a PSSCH corresponding to a PSFCH or a priority class carried in first SCI received by the first terminal device, where the first SCI indicates the PSSCH corresponding to the PSFCH. Optionally, a priority class is expressed in a priority class value. In the case where a larger priority class value represents a higher priority class, the case that the priority class of the data to be transmitted by the first terminal device on the carrier triggered for reporting of the candidate resource set is lower than or equal to the priority class of PSFCH transmission performed by the first terminal device means that a priority class value of the data to be transmitted by the first terminal device on the carrier triggered for reporting of the candidate resource set is lower than or equal to a priority class value of PSFCH transmission performed by the first terminal device. In the case where a smaller priority class value represents a higher priority class, the case that the priority class of the data to be transmitted by the first terminal device on the carrier triggered for reporting of the candidate resource set is lower than or equal to the priority class of PSFCH transmission performed by the first terminal device means that the priority class value of the data to be transmitted by the first terminal device on the carrier triggered for reporting of the candidate resource set is greater than or equal to the priority class value of PSFCH transmission performed by the first terminal device.

Optionally, the PSFCH resource determined according to the first resource refers to a corresponding PSFCH resource determined according to at least one or more of: a time-domain position of the first resource, a frequency-domain position of the first resource, or a source ID for the first terminal device. Optionally, there may be one source ID for the first terminal device. For example, a single source ID is allocated to the first terminal device, and the first terminal device uses this single source ID for each data transmission. Optionally, there may be multiple source IDs for the first terminal device. For example, multiple source IDs are allocated to the first terminal device, and the first terminal device may use different source IDs for different times of data transmission. In addition, in the case where it is determined that the corresponding PSFCH resource is required to use a source ID for the first terminal device and in the case where a single source ID is allocated to the first terminal device, the source ID used is this single source ID. Alternatively, in the case where the corresponding PSFCH resource is required to use a source ID for the first terminal device and in the case where multiple source IDs are allocated to the first terminal device, the source ID used may be a source ID corresponding to data to be transmitted.

Optionally, the PSFCH resource is a time-domain resource, a time-frequency resource, or a code-domain resource corresponding to a time-frequency resource.

Optionally, the candidate resource set is an initialized resource set and contains all resources belonging to a resource pool for the first terminal device within a resource selection window. Optionally, the candidate resource set is a resource set subject to resource exclusion and contains resources remaining in the initialized resource set subject to resource exclusion, such as a resource set obtained by performing resource exclusion, for example, step 1-1 and/or step 1-2, on the initialized resource set. For introduction and explanation of step 1-1 and step 1-2, reference can be made to the above, which is not repeated herein.

Optionally, in the case where the first terminal device performs transmission using multiple resource pools on multiple carriers, the multiple carriers have the same subcarrier spacing, the same time division duplex (TDD) configuration, the same synchronization resource configuration, the same starting symbol available for SL transmission in a slot, and the same number of symbols available for SL transmission in a slot, and the multiple resource pools have the same PSFCH period and the same corresponding bitmap. In a CA transmission scenario, by means of the above limitations to the multiple carriers and the multiple resource pools, the consistency of transmission configurations on the multiple carriers and the consistency of configurations of the multiple resource pools can be ensured, which is conducive to reducing processing complexity of resource selection and resource exclusion, thereby improving communication reliability.

Optionally, the capability of simultaneous transmission is indicated to the first terminal device by a second terminal device. In an example, the capability of simultaneous transmission is indicated by the number of carriers, N1, and the number of the carriers, N1, indicates that simultaneous transmission on at most NI carriers is supported or simultaneous PSFCH transmission on at most NI carriers is supported. For example, N1=2 indicates that simultaneous transmission on at most 2 carriers is supported, or indicates that simultaneous PSFCH transmission on at most 2 carriers is supported. In another example, the capability of simultaneous transmission is indicated via one or more carrier lists, where each of the one or more carrier lists indicates carriers simultaneous transmission on which is supported or indicates carriers simultaneous PSFCH transmission on which is supported. For example, the carrier list contains carrier 1 and carrier 3, which indicates that simultaneous transmission on carrier 1 and carrier 3 is supported, or indicates that simultaneous PSFCH transmission on carrier 1 and carrier 3 is supported. Optionally, the second terminal device is a receiving terminal of the first terminal device, or any one terminal device other than the first terminal device. The receiving terminal of the first terminal device refers to a peer device that performs SL communication with the first terminal device.

Optionally, the capability of simultaneous transmission is specified by a standard, configured by a network, or pre-configured. That the capability of simultaneous transmission is specified by a standard is taken as an example, in this case, the minimum value and/or the maximum value of the number of carriers simultaneous transmission on which is supported may be specified by the standard, or the minimum value and/or the maximum value of the number of the carriers simultaneous PSFCH transmission on which is supported may be specified by the standard.

Optionally, the carrying capability of the PSFCH means the maximum number of bits carriable by the PSFCH. For example, the maximum number of the bits carriable by the PSFCH is 2 bits, which means that the number of bits of HARQ information transmitted on the PSFCH may be less than or equal to 2 bits.

Optionally, the HARQ information is fed back by a receiving terminal of the first terminal device.

Optionally, the PSFCH resource determined according to the first resource is in conflict with the resource on which the first terminal device is to perform PSFCH transmission as follows. The PSFCH resource determined according to the first resource and the resource on which the first terminal device is to perform PSFCH transmission overlap in a time domain. Optionally, overlapping in the time domain may refer to partial overlapping or full overlapping. For example, in the case where there is at least one overlapping symbol in the time domain between the PSFCH resource determined according to the first resource and the resource on which the first terminal device is to perform PSFCH transmission, it is considered that the two resources overlap in the time domain.

Optionally, the resource on which the first terminal device is to perform PSFCH transmission is determined according to a resource on which data is received by the first terminal device. For example, the first terminal device determines, according to a time-domain position of the resource on which data is received by the first terminal device, a time-domain position of the resource on which the first terminal device is to perform PSFCH transmission. Optionally, the resource on which the first terminal device is to perform PSFCH transmission is determined according to a resource indicated via SCI received by the first terminal device. For example, the first terminal device determines, according to a time-domain position of the resource indicated via the SCI received, the time-domain position of the resource on which the first terminal device is to perform PSFCH transmission. Exemplarily, the first terminal device determines, according to a resource for next transmission indicated via the SCI received by the first terminal device, the PSFCH resource corresponding to the resource for next transmission.

Optionally, a cause that the first terminal device does not support transmission on the first resource or on the resource(s) corresponding to the first resource includes at least one of: limitation in the number of carriers simultaneous transmission on which is supported by the first terminal device, limitation in CA, or interruption due to RF retuning. For introduction and explanation of these three limitation conditions, reference can be made to the above, which is not repeated herein.

Optionally, the first terminal device does not support transmission on the first resource or on the resource(s) corresponding to the first resource as follows. The first terminal device does not support transmission on the first resource or on one or more of the resource(s) corresponding to the first resource. Optionally, the one or more of the resource(s) corresponding to the first resource refer to one or more of the periodic resource(s) corresponding to the first resource.

Optionally, in the case where the first terminal device does not support transmission on Y resources among the periodic resource(s) corresponding to the first resource and in the case where Y is greater than or equal to a second value, the first terminal device determines that the first condition is satisfied and excludes the first resource from the candidate resource set. The second value may be understood as a threshold, and the second value may be configured by a network, pre-configured, up to first terminal device implementation, or a preset value specified by a standard. Exemplarily, assuming that the second value is 2, whether the first terminal device supports transmission on each of the periodic resource(s) corresponding to the first resource is determined. In the case where there are two or more resources transmission on which is not supported, the first terminal device determines that the first condition is satisfied and excludes the first resource from the candidate resource set; otherwise, the first terminal device determines that the first condition is not satisfied and remains the first resource in the candidate resource set.

In the technical solution provided in embodiments of the disclosure, during resource selection, factors such as a transmission capability of a terminal device that performs feedback or a capability of a PSFCH or a conflict between PSFCH transmission and PSFCH reception are taken into consideration, so that the case that the terminal device cannot perform PSFCH transmission or PSFCH sensing can be avoided, thereby improving reliability of an HARQ feedback mechanism, and accordingly improving communication reliability.

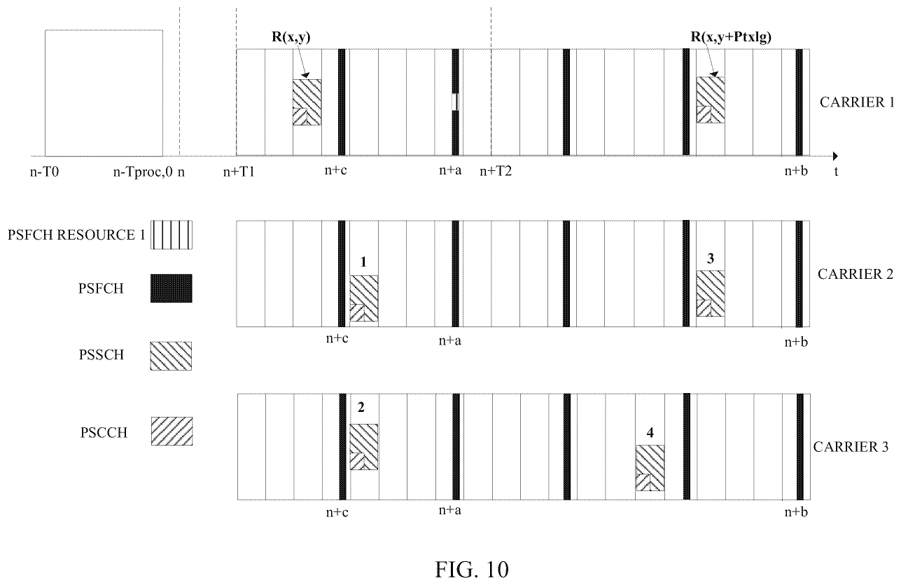

The following introduces and describes the technical solutions of the disclosure by means of several exemplary embodiments with reference to FIG. 10.

As illustrated in FIG. 10, on carrier 1, UE 1 triggers resource selection or resource reselection in slot n or a higher layer triggers a physical layer to report a candidate resource set in slot n. UE 1 defines a resource selection window 10 from n+T₁ to n+T₂ and a resource sensing window 20 from n-T₀ to n-T_{proc,0}. Exemplarily, for definitions of T₁, T₂, T₀, and T_{proc,0}, reference can be made to the above. UE 1 initializes candidate resource set A to contain a set of all resources belonging to a resource pool used by UE 1 within the resource selection window 10.

For any one resource R(x,y) in candidate resource set A, UE 1 excludes R(x,y) from candidate resource set A in the case where R(x,y) or a periodic resource(s) corresponding to R(x,y) satisfies at least one of: a PSFCH resource determined according to R(x,y) is to cause that simultaneous PSFCH transmission exceeds a capability of simultaneous transmission; the PSFCH resource determined according to R(x,y) is to cause that HARQ information to be fed back exceeds a carrying capability of a PSFCH; the PSFCH resource determined according to R(x,y) is in conflict with a resource on which UE 1 is to perform PSFCH transmission; or UE 1 does not support transmission on R(x,y) or on the periodic resource(s) corresponding to R(x,y).

Candidate resource set A may refer to initialized candidate resource set A, i.e., candidate resource set A contains all resources belonging to the resource pool used by UE 1 within the resource selection window 10. Optionally, candidate resource set A may be candidate resource set A subject to resource exclusion, i.e., candidate resource set A contains resources remaining in initialized candidate resource set A subject to resource exclusion, such as may be candidate resource set A subject to step 1-1 and/or step 1-2.

In an exemplary embodiment, UE 1 excludes resource R(x,y) from candidate resource set A in the case where the PSFCH resource determined according to R(x,y) or a PSFCH resource(s) determined according to one or more of R(x,y+j*Ptxlg) is to cause that simultaneous PSFCH transmission exceeds the capability of simultaneous transmission.

Optionally, the capability of simultaneous transmission may refer to a capability of simultaneous transmission of a receiving terminal of UE 1 or may be a capability of simultaneous transmission that is specified by a standard or configured by a network or pre-configured. The capability of simultaneous transmission specified by the standard or configured by the network or pre-configured may refer to a capability of simultaneous transmission common to all UEs.

Optionally, the capability of simultaneous transmission contains the number of carriers, N1, i.e., simultaneous transmission on at most N1 carriers is supported or simultaneous PSFCH transmission on at most N1 carriers is supported.

Optionally, the capability of simultaneous transmission is indicated via one or more carrier lists, where each of the one or more carrier lists indicates carriers simultaneous transmission on which is supported or indicates carriers simultaneous PSFCH transmission on which is supported.

Optionally, the capability of simultaneous transmission may be configured by the network or pre-configured or specified by the standard or indicated to UE 1 by UE 2. UE 2 may be a receiving terminal of UE 1, or any one UE other than UE 1.

Optionally, UE 1 excludes resource R(x,y) from candidate resource set A in the case where the PSFCH resource determined according to R(x,y) is to cause that simultaneous PSFCH transmissions exceeds the capability of simultaneous transmission. For example, in FIG. 10, UE 1 has already selected resource 1 on carrier 2 and resource 2 on carrier 3, a corresponding PSFCH resource determined according to resource 1 is located in slot n+a on carrier 2, and a corresponding PSFCH resource determined according to resource 2 is located in slot n+a on carrier 3. It is assumed that the UE supports simultaneous PSFCH transmissions on at most 2 carriers. For any one resource R(x,y) in candidate resource set A, in the case where the PSFCH resource determined according to resource R(x,y) is located in slot n+a, it results in that the UE needs to simultaneously perform PSFCH transmission on three carriers, which exceeds the capability of the UE, and thus the UE excludes resource R(x,y) from candidate resource set A. In another example, in FIG. 10, UE 1 has already selected resource 1 on carrier 2 and resource 2 on carrier 3, a corresponding PSFCH resource determined according to resource 1 is located in slot n+a on carrier 2, and a corresponding PSFCH resource determined according to resource 2 is located in slot n+a on carrier 3. It is assumed that a carrier list reported by the receiving terminal of UE 1 contains carrier 2 and carrier 3 simultaneous PSFCH transmission on which is supported. For any one resource R(x,y) in candidate resource set A, in the case where the PSFCH resource determined according to resource R(x,y) is located in slot n+a, UE 1 excludes resource R(x,y) from candidate resource set A according to the carrier list.

Optionally, in the case where a PSFCH resource(s) determined according to one or more of R(x,y+j*Ptxlg) is to cause that simultaneous PSFCH transmission exceeds the capability of simultaneous transmission, UE 1 excludes resource R(x,y) from candidate resource set A. j=0, 1, . . . , Cresel-1, Cresel is related to a random count value generated by UE 1, Ptx represents a resource reservation period for UE 1, and Ptxlg represents the number of logical slots converted from Ptx. For example, whether each resource corresponding to R(x,y+j*Ptxlg) is to cause that simultaneous PSFCH transmission exceeds the capability of simultaneous transmission (noted as satisfying a first target condition) is determined according to the above operations on resource R(x,y). For example, among a resource(s) corresponding to R(x,y+j*Ptxlg), in the case where there is a resource that satisfies the first target condition, UE 1 excludes resource R(x,y) from candidate resource set A. For another example, among the resource(s) corresponding to R(x,y+j*Ptxlg), in the case where the number of resources satisfying the first target condition is greater than or equal to a first threshold, UE 1 excludes resource R(x,y) from candidate resource set A. The first threshold is configured by the network, pre-configured, up to UE 1 implementation, or a preset value specified by the standard. For example, in FIG. 10, in the case where UE 1 performs resource selection on carrier 1 and assuming that the receiving terminal of UE 1 reports that simultaneous PSFCH transmission can be performed on at most two carriers, for any one resource R(x,y) in candidate resource set A, both R(x,y) and R(x,y+Ptxlg) satisfy the first target condition (i.e., the number of carriers on which PSFCH transmission is to be performed by the receiving terminal in slot n+a and the number of carriers on which PSFCH transmission is to be performed by the receiving terminal in slot n+b are both greater than 1), and thus UE 1 excludes resource R(x,y) from candidate resource set A.

Optionally, in the case where the PSFCH resource determined according to R(x,y) or the PSFCH resource(s) determined according to one or more of R(x,y+j*Ptxlg) is to cause that simultaneous PSFCH transmission exceeds the capability of simultaneous transmission and in the case where a priority class of data to be transmitted by UE 1 on a carrier on which resource selection is performed is lower than or equal to a second threshold, UE 1 excludes resource R(x,y) from candidate resource set A. The second threshold is configured by the network, pre-configured, up to UE 1 implementation, or a preset value specified by the standard.

Optionally, in the case where the PSFCH resource determined according to R(x,y) or the PSFCH resource(s) determined according to one or more of R(x,y+j*Ptxlg) is to cause that simultaneous PSFCH transmission exceeds the capability of simultaneous transmission, UE 1 determines, according to a priority class of data to be transmitted on a carrier (e.g., carrier 1) on which resource selection is performed and a priority class of data transmitted on carriers (e.g., carrier 2 and carrier 3) from which a resource has been selected, whether to exclude resource R(x,y) from candidate resource set A.

In an exemplary embodiment, in the case where the PSFCH resource determined according to R(x,y) or the PSFCH resource(s) determined according to one or more of R(x,y+j*Ptxlg) is to cause that HARQ information to be fed back exceeds a carrying capability of a PSFCH, UE 1 excludes resource R(x,y) from candidate resource set A.

Optionally, the carrying capability of the PSFCH means the maximum number of bits carriable by the PSFCH.

Optionally, in the case where the PSFCH resource determined according to R(x,y) is to cause that HARQ information to be fed back exceeds the maximum number of bits carriable by the PSFCH, UE 1 excludes resource R(x,y) from candidate resource set A. For example, in FIG. 10, UE 1 has already selected resource 1 on carrier 2 and resource 2 on carrier 3, both a corresponding PSFCH resource determined according to resource 1 and a corresponding PSFCH resource determined according to resource 2 are PSFCH resource 1 on carrier 1. It is assumed that PSFCH resource 1 can carry only 2-bit HARQ information to be fed back. In the case where UE 1 performs resource selection on carrier 1, for resource R(x,y) in the candidate resource set, a corresponding PSFCH resource determined according to resource R(x,y) also is PSFCH resource 1 on carrier 1, i.e., UE 1 needs to feed back 3-bit HARQ information over PSFCH resource 1, which exceeds the maximum number of bits carriable by PSFCH resource 1, and thus UE 1 excludes resource R(x,y) from candidate resource set A.

Optionally, in the case where a PSFCH resource(s) determined according to one or more of R(x,y+j*Ptxlg) is to cause that HARQ information to be fed back exceeds the maximum number of bits carriable by the PSFCH, UE 1 excludes resource R(x,y) from candidate resource set A. j-0, 1, . . . , Cresel-1, Cresel is related to a random count value generated by UE 1, Ptx represents a resource reservation period for UE 1, and Ptxlg represents the number of logical slots converted from Ptx. For example, whether each resource corresponding to R(x,y+j*Ptxlg) is to cause that HARQ information to be fed back exceeds the maximum number of bits carriable by the PSFCH (noted as satisfying a second target condition) is determined according to the above operations over resource R(x,y). For example, among a resource(s) corresponding to R(x,y+j*Ptxlg), in the case where there is a resource that satisfies the second target condition, UE 1 excludes resource R(x,y) from candidate resource set A. For another example, among the resource(s) corresponding to R(x,y+j*Ptxlg), in the case where the number of resources satisfying the second target condition is greater than or equal to a third threshold, UE 1 excludes resource R(x,y) from candidate resource set A. The third threshold is configured by the network, pre-configured, up to UE 1 implementation, or a preset value specified by the standard

Optionally, in the case where the PSFCH resource determined according to R(x,y) or the PSFCH resource(s) determined according to one or more of R(x,y+j*Ptxlg) is to cause that HARQ information to be fed back exceeds the maximum number of bits carriable by the PSFCH and in the case where the priority class of the data to be transmitted by UE 1 on the carrier on which resource selection is performed is lower than or equal to a fourth threshold, UE 1 excludes resource R(x,y) from candidate resource set A. The fourth threshold is configured by the network, pre-configured, up to UE 1 implementation, or a preset value specified by the standard.

Optionally, in the case where the PSFCH resource determined according to R(x,y) or the PSFCH resource(s) determined according to one or more of R(x,y+j*Ptxlg) is to cause that HARQ information to be fed back exceeds the maximum number of bits carriable by the PSFCH, UE 1 determines, according to a priority class of data to be transmitted on a carrier (e.g., carrier 1) on which resource selection is performed and a priority class of data transmitted on carriers (e.g., carrier 2 and carrier 3) from which a resource has been selected, whether to exclude resource R(x,y) from candidate resource set A.

In an exemplary embodiment, in the case where the PSFCH resource determined according to R(x,y) or the PSFCH resource(s) determined according to one or more of R(x,y+j*Ptxlg) is in conflict with a resource on which UE 1 is to perform PSFCH transmission, UE 1 excludes resource R(x,y) from candidate resource set A.

Optionally, the PSFCH resource determined according to R(x,y) is in conflict with the resource on which UE 1 is to perform PSFCH transmission as follows. The PSFCH resource determined according to R(x,y) and the resource on which UE 1 is to perform PSFCH transmission overlap in the time domain.

Optionally, the resource on which UE 1 is to perform PSFCH transmission is determined according to a resource over which data is received by UE 1. For example, in the case where UE 1 receives a PSSCH in slot n-1 on carrier 2, UE 1 needs to perform HARQ feedback in slot n+c on carrier 2.

Optionally, the resource on which UE 1 is to perform PSFCH transmission is determined according to a resource indicated via SCI received by UE 1. For example, UE 1 has received first SCI before slot n on carrier 2, and the first SCI indicates resource 1 on carrier 2, and thus UE 1 determines according to resource 1 to transmit in slot n+a a PSFCH for HARQ feedback.

Optionally, UE 1 excludes resource R(x,y) from candidate resource set A in the case where the PSFCH resource determined according to R(x,y) and the resource on which UE 1 is to perform PSFCH transmission overlap in the time domain. For example, in FIG. 10, UE 1 has received the first SCI before slot n on carrier 2, and the first SCI indicates resource 1, and thus UE 1 determines, according to resource 1, to perform HARQ feedback in slot n+a on carrier 2. Assuming that carrier 1 and carrier 2 are in the same frequency band, i.e., in an intra-band scenario, UE 1 cannot perform transmission on carrier 2 and reception on carrier 1 at the same time due to half-duplex limitation. During resource selection on carrier 1 by UE 1, in the case where the PSFCH resource determined according to any one resource R(x,y) in the candidate resource set is located in slot n+a, UE 1 needs to perform PSFCH reception in slot n+a on carrier 1 which overlaps in time domain slot n+a on carrier 2 in which UE 1 is to perform PSFCH transmission. Therefore, resource R(x,y) needs to be excluded from candidate resource set A.

Optionally, in the case where the PSFCH resource(s) determined according to one or more of R(x,y+j*Ptxlg) and the resource on which UE 1 is to perform PSFCH transmission overlap in the time domain, UE 1 excludes resource R(x,y) from candidate resource set A. j=0, 1, . . . , Cresel-1, Cresel is related to a random count value generated by UE 1, Ptx represents a resource reservation period for UE 1, and Ptxlg represents the number of logical slots converted from Ptx. For example, whether each resource corresponding to R(x,y+j*Ptxlg) and the resource on which UE 1 is to perform PSFCH transmission overlap in the time domain (noted as satisfying a third target condition) is determined according to the above operations over resource R(x,y). For example, among a resource(s) corresponding to R(x,y+j*Ptxlg), in the case where there is a resource that satisfies the third target condition, UE 1 excludes resource R(x,y) from candidate resource set A. For another example, among the resource(s) corresponding to R(x,y+j*Ptxlg), in the case where the number of resources satisfying the third target condition is greater than or equal to a fifth threshold, UE 1 excludes resource R(x,y) from candidate resource set A. The fifth threshold is configured by the network, pre-configured, up to UE 1 implementation, or a preset value specified by the standard.

Optionally, in the case where the PSFCH resource determined according to R(x,y) or the PSFCH resource(s) determined according to one or more of R(x,y+j*Ptxlg) and the resource on which UE 1 is to perform PSFCH transmission overlap in the time domain and in the case where the priority class of the data to be transmitted by UE 1 on the carrier on which resource selection is performed is lower than or equal to a sixth threshold, UE 1 excludes resource R(x,y) from candidate resource set A. The sixth threshold is configured by the network, pre-configured, up to UE 1 implementation, or a preset value specified by the standard.

Optionally, in the case where the PSFCH resource determined according to R(x,y) or the PSFCH resource(s) determined according to one or more of R(x,y+j*Ptxlg) and the resource on which UE 1 is to perform PSFCH transmission overlap in the time domain, UE 1 determines, according to a priority class of data to be transmitted on a carrier (e.g., carrier 1) on which resource selection is performed and a priority class of PSFCH transmission to be performed, whether to exclude resource R(x,y) from candidate resource set A. The priority class of PSFCH transmission to be performed is a priority class of data received by UE 1 in a PSSCH corresponding to a PSFCH or a priority class carried in first SCI received by UE 1, and the first SCI indicates the PSSCH corresponding to the PSFCH.

In an exemplary embodiment, in the case where UE 1 does not support transmission on R(x,y) or on a periodic resource(s) corresponding to R(x,y), UE 1 excludes resource R(x,y) from candidate resource set A.

Optionally, under limitation in the number of carriers simultaneous transmission on which is supported by UE 1 or limitation in CA or interruption due to RF tuning, in the case where UE 1 does not support transmission on R(x,y), UE 1 excludes resource R(x,y) from candidate resource set A. For example, in FIG. 10, UE 1 has already selected resource 1 on carrier 2 and resource 2 on carrier 3, and UE 1 can simultaneously perform transmission on at most two carriers. During resource selection on carrier 1 by UE 1, in the case where any one resource R(x,y) in candidate resource set A overlaps both resource 1 and resource 2 in the time domain, UE 1 excludes resource R(x,y) from the candidate resource set. In another example, in FIG. 10, UE 1 has already selected resource 1 on carrier 2, and UE 1 does not support simultaneous transmission on carrier 1 and carrier 2. During resource selection on carrier 1 by UE 1, in the case where any one resource R(x,y) in candidate resource set A overlaps resource 1 in the time domain, UE 1 excludes resource R(x,y) from the candidate resource set. In another example, in FIG. 10, UE 1 has already selected resource 1 on carrier 2, and UE 1 does not support simultaneous transmission on carrier 1 and carrier 2. After transmission on carrier 2, UE 1 needs to retune RF or hardware to repeat transmission over carrier 1. During resource selection on carrier 1 by UE 1, in the case where any one resource R(x,y) in candidate resource set A overlaps an RF retuning time corresponding to resource 1 in the time domain, UE 1 excludes resource R(x,y) from the candidate resource set.

Optionally, under limitation in the number of carriers simultaneous transmission on which is supported by UE 1 or limitation in CA or interruption due to RF tuning, UE 1 does not support transmission on one or more of R(x,y+j*Ptxlg) and thus UE 1 excludes resource R(x,y) from candidate resource set A. j=0, 1, . . . , Cresel-1, Cresel is related to a random count value generated by UE 1, Ptx represents a resource reservation period for UE 1, and Ptxlg represents the number of logical slots converted from Ptx. For example, whether UE 1 supports transmission on each resource corresponding to R(x,y+j*Ptxlg) (noted as satisfying a fourth target condition) is determined according to the above operations on resource R(x,y). For example, among a resource(s) corresponding to R(x,y+j*Ptxlg), in the case where there is a resource that satisfies the fourth target condition, UE 1 excludes resource R(x,y) from candidate resource set A. For another example, among the resource(s) corresponding to R(x,y+j*Ptxlg), in the case where the number of resources satisfying the fourth target condition is greater than or equal to a seventh threshold, UE 1 excludes resource R(x,y) from candidate resource set A. The seventh threshold is configured by the network, pre-configured, up to UE 1 implementation, or a preset value specified by the standard.

Optionally, in any one of the above exemplary embodiments, the PSFCH resource determined according to resource R(x,y) or resource 1/2/3/4 refers to that a corresponding PSFCH resource is determined according to at least one or more of: a time-domain position of resource R(x,y) or a time-domain position of resource 1/2/3/4, a frequency-domain position of resource R(x,y) or a frequency-domain position of resource 1/2/3/4, or a source ID for UE 1.

Optionally, in any one of the above exemplary embodiments, the PSFCH resource is a time-domain resource, a time-frequency resource, or a code-domain resource (e.g., a code-domain sequence) corresponding to a time-frequency resource.

Optionally, in the case where UE 1 performs transmission using multiple resource pools on multiple carriers, it is necessary to ensure that the multiple carriers at least have the same subcarrier spacing, the same TDD configuration, the same synchronization resource configuration (e.g., SSB transmission resource configuration), the same starting symbol (e.g., sl-StartSymbol-r16) available for SL transmission in a slot, and the same number (e.g. sl-LengthSymbols-r16) of symbols available for SL transmission in a slot. It is also ensured that the multiple resource pools have at least the same PSFCH period and the same corresponding bitmap.

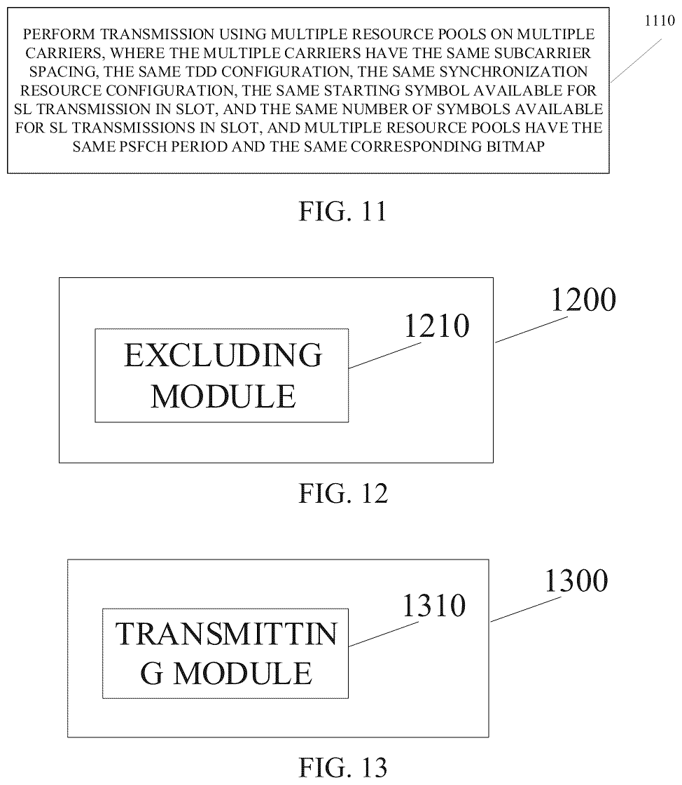

Refer to FIG. 11, which is a flow chart illustrating a method for data transmission provided in an embodiment of the disclosure. The method may be applied in a network architecture illustrated in FIG. 1, e.g., the method may be performed by a first terminal device. The method includes the following.

At 1110, transmission is performed using multiple resource pools on multiple carriers. The multiple carriers have the same subcarrier spacing, the same TDD configuration, the same synchronization resource configuration, the same starting symbol available for SL transmission in a slot, and the same number of symbols available for SL transmissions in a slot, and the multiple resource pools have the same PSFCH period and the same corresponding bitmap.

With the technical solutions provided in embodiments of the disclosure, in a CA transmission scenario, by means of the above limitations to the multiple carriers and the multiple resource pools, the consistency of transmission configurations on the multiple carriers and the consistency of configurations of the multiple resource pools can be ensured, which is conducive to reducing processing complexity of resource selection and resource exclusion, thereby improving communication reliability.

The following are apparatus embodiments of the disclosure, and the method embodiments of the disclosure can be performed. For undisclosed details of the apparatus embodiments of the disclosure, reference can be made to the method embodiments of the disclosure.

Refer to FIG. 12, which is a block diagram illustrating an apparatus for resource exclusion provided in an embodiment of the disclosure. The apparatus has functions to implement examples of the method for resource exclusion, the functions may be implemented through hardware or through corresponding software executed by hardware. The apparatus may be the first terminal device introduced above or may be disposed in the first terminal device. As illustrated in FIG. 12, the apparatus 1200 may include an excluding module 1210. The excluding module 1210 is configured to exclude a first resource from a candidate resource set, in the case where the first resource in the candidate resource set or a resource(s) corresponding to the first resource satisfies a first condition. The first condition includes at least one of: a PSFCH resource determined according to the first resource is to cause that simultaneous PSFCH transmission exceeds a capability of simultaneous transmission; the PSFCH resource determined according to the first resource is to cause that HARQ information to be fed back exceeds a carrying capability of a PSFCH; the PSFCH resource determined according to the first resource is in conflict with a resource on which a first terminal device is to perform PSFCH transmission; or the first terminal device does not support transmission on the first resource or on the resource(s) corresponding to the first resource.

Optionally, the resource(s) corresponding to the first resource includes: a periodic resource(s) corresponding to the first resource. The first resource is represented as R(x,y), x indicates a time-domain position of the first resource, and y indicates a frequency-domain position of the first resource. The periodic resource(s) corresponding to the first resource is represented as R(x,y+j*Ptxlg), j is an integer belonging to [0,Cresel-1], Cresel is related to a random count value generated by the first terminal device, Ptxlg represents number of logical slots converted from Ptx, and Ptx represents a resource reservation period for the first terminal device.

Optionally, the PSFCH resource determined according to the first resource includes: the PSFCH resource determined merely according to the first resource; or the PSFCH resource determined according to one or more of the periodic resource(s) corresponding to the first resource.

Optionally, the excluding module 120 is configured to exclude the first resource from the candidate resource set, in the case where the first resource or the resource(s) corresponding to the first resource satisfies the first condition and in the case where a priority class of data to be transmitted by the first terminal device on a carrier triggered for reporting of the candidate resource set satisfies a second condition.

Optionally, the second condition includes at least one of: the priority class of the data to be transmitted by the first terminal device on the carrier triggered for reporting of the candidate resource set is lower than or equal to a threshold; a relationship between the priority class of the data to be transmitted by the first terminal device on the carrier triggered for reporting of the candidate resource set and a priority class of data transmitted on a carrier from which a resource has been selected satisfies a third condition; or a relationship between the priority class of the data to be transmitted by the first terminal device on the carrier triggered for reporting of the candidate resource set and a priority class of PSFCH transmission performed by the first terminal device satisfies a fourth condition.

Optionally, the PSFCH resource determined according to the first resource refers to a corresponding PSFCH resource determined according to at least one or more of: a time-domain position of the first resource, a frequency-domain position of the first resource, or a source ID for the first terminal device.

Optionally, the PSFCH resource is a time-domain resource, a time-frequency resource, or a code-domain resource corresponding to a time-frequency resource.

Optionally, the candidate resource set is an initialized resource set and contains all resources belonging to a resource pool for the first terminal device within a resource selection window; or the candidate resource set is a resource set subject to resource exclusion and contains resources remaining in the initialized resource set subject to resource exclusion.

Optionally, in the case where the first terminal device performs transmission using multiple resource pools on multiple carriers, the multiple carriers have the same subcarrier spacing, the same TDD configuration, the same synchronization resource configuration, the same starting symbol available for SL transmission in a slot, and the same number of symbols available for SL transmission in a slot, and the multiple resource pools have the same PSFCH period and the same corresponding bitmap.

Optionally, the capability of simultaneous transmission is indicated to the first terminal device by a second terminal device.

Optionally, the capability of simultaneous transmission is indicated by number of carriers, N1, and the number of the carriers, N1, indicates that simultaneous transmission on at most N1 carriers is supported or simultaneous PSFCH transmission on at most N1 carriers is supported.

Optionally, the capability of simultaneous transmission is indicated via one or more carrier lists, where each of the one or more carrier lists indicates carriers simultaneous transmission on which is supported or indicates carriers simultaneous PSFCH transmission on which is supported.

Optionally, the second terminal device is a receiving terminal of the first terminal device, or any one terminal device other than the first terminal device.

Optionally, the capability of simultaneous transmission is specified by a standard, configured by a network, or pre-configured.

Optionally, the carrying capability of the PSFCH means a maximum number of bits carriable by the PSFCH.

Optionally, the HARQ information is fed back by a receiving terminal of the first terminal device.

Optionally, the PSFCH resource determined according to the first resource is in conflict with the resource on which the first terminal device is to perform PSFCH transmission as follows. The PSFCH resource determined according to the first resource and the resource on which the first terminal device is to perform PSFCH transmission overlap in a time domain.

Optionally, the resource on which the first terminal device is to perform PSFCH transmission is determined according to a resource over which data is received by the first terminal device.

Optionally, the resource on which the first terminal device is to perform PSFCH transmission is determined according to a resource indicated via SCI received by the first terminal device.

Optionally, a cause that the first terminal device does not support transmission on the first resource or on the resource(s) corresponding to the first resource includes at least one of: limitation in the number of carriers simultaneous transmission on which is supported by the first terminal device, limitation in CA, or interruption due to RF retuning.

Refer to FIG. 13, which is a block diagram illustrating an apparatus for data transmission provided in an embodiment of the disclosure. The apparatus has functions to implement examples of the method for resource exclusion, the functions may be implemented through hardware or through corresponding software executed by hardware. The apparatus may be the first terminal device introduced above or may be disposed in the first terminal device. As illustrated in FIG. 13, the apparatus 1300 may include a transmitting module 1310. The transmitting module 1310 is configured to perform transmission using multiple resource pools on multiple carriers. The multiple carriers have the same subcarrier spacing, the same TDD configuration, the same synchronization resource configuration, the same starting symbol available for SL transmission in a slot, and the same number of symbols available for SL transmissions in a slot, and the multiple resource pools have the same PSFCH period and the same corresponding bitmap.

It may be noted that, when the apparatus provided in the foregoing embodiments implements its functions, only the division into the above functional modules is taken an example for illustration. In practice, the above functions can be allocated to different functional modules according to actual needs, that is, the structure of the device is divided into different functional modules to complete all or some of the functions described above.

Regarding the apparatus in the foregoing embodiments, the manner in which each module performs operations has been described in detail in the related method embodiments and thus will not be elaborated again herein. For details not specified in the apparatus embodiments, reference can be made to the method embodiments above.

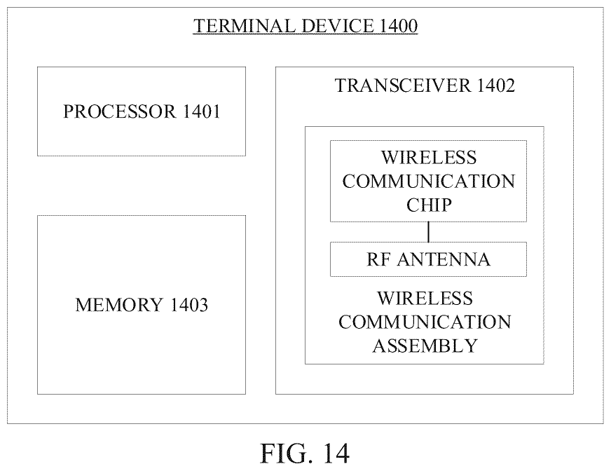

Refer to FIG. 14, which is a schematic structural diagram illustrating a terminal device provided in an embodiment of the disclosure. The terminal device 1400 may include a processor 1401, a transceiver 1402, and a memory 1403.

The processor 1401 includes one or more processing cores, and the processor 1401 executes various function applications and information processing by running software programs and modules.

The transceiver 1402 may include a receiver and a transmitter. For example, the receiver and the transmitter may be implemented as a wireless communication assembly, and the wireless communication assembly may be a wireless communication chip and an RF antenna.

The memory 1403 may be connected to the processor 1401 and the transceiver 1402.

The memory 1403 may be configured to store computer programs executed by the processor. The processor 1401 is configured to execute the computer programs to implement various steps in the foregoing method embodiments.

In an exemplary embodiment, the processor 1401 is configured to exclude a first resource from a candidate resource set, in the case where the first resource in the candidate resource set or a resource(s) corresponding to the first resource satisfies a first condition. The first condition includes at least one of: a PSFCH resource determined according to the first resource is to cause that simultaneous PSFCH transmission exceeds a capability of simultaneous transmission; the PSFCH resource determined according to the first resource is to cause that HARQ information to be fed back exceeds a carrying capability of a PSFCH; the PSFCH resource determined according to the first resource is in conflict with a resource on which a first terminal device is to perform PSFCH transmission; or the first terminal device does not support transmission on the first resource or on the resource(s) corresponding to the first resource.

In another exemplary embodiment, the transceiver 1402 is configured to perform transmission using multiple resource pools on multiple carriers. The multiple carriers have the same subcarrier spacing, the same TDD configuration, the same synchronization resource configuration, the same starting symbol available for SL transmission in a slot, and the same number of symbols available for SL transmissions in a slot, and the multiple resource pools have the same PSFCH period and the same corresponding bitmap.

For details not specified in the embodiment, reference can be made to the embodiments above, which is not repeated herein.

In addition, the memory may be implemented by any type of volatile storage device or non-volatile storage device or a combination thereof. The volatile storage device or non-volatile storage device includes, but is not limited to, a magnetic disk or an optical disk, an electrically erasable programmable read-only memory (ROM), an erasable programmable ROM, a static random-access memory (RAM), an ROM, a magnetic memory, a flash memory, and a programmable ROM.

A computer-readable storage medium is further provided in embodiments of the disclosure. The storage medium is configured to store computer programs. The computer programs are configured to be executed by a processor to implement the method for resource exclusion or the method for data transmission. Optionally, the computer-readable storage medium may include: an ROM, an RAM, a solid state drive (SSD), an optical disc, etc. The RAM may include a resistance RAM (ReRAM) and a dynamic RAM (DRAM).

A chip is further provided in embodiments of the disclosure. The chip includes a programmable logic circuit and/or program instructions. The chip in operation is configured to implement the method for resource exclusion or the method for data transmission.

A computer program product or a computer program is further provided in embodiments of the disclosure. The computer program product or the computer program includes computer instructions stored in a computer-readable storage medium. A processor is configured to read and execute the computer instructions to implement the method for resource exclusion or the method for data transmission.

It may be understood that, “indication” referred to in embodiments of the disclosure may be a direct indication, may be an indirect indication, or may mean that there is an association relationship. For example, A indicates B may mean that A directly indicates B, for instance, B can be obtained according to A; may mean that A indirectly indicates B, for instance, A indicates C, and B can be obtained according to C; or may mean that that there is an association relationship between A and B.

In the elaboration of embodiments of the disclosure, the term “correspondence” may mean that there is a direct or indirect correspondence between the two, may mean that there is an association between the two, or may mean a relationship of indicating and indicated or configuring and configured, etc.

In embodiments of the disclosure, the “pre-defined” can be implemented by pre-saving a corresponding code or table in a device (for example, including the terminal device and the network device) or in other manners that can be used for indicating related information, and the disclosure is not limited in this regard. For example, the “pre-defined” may mean defined in a protocol.

In embodiments of the disclosure, the “protocol” may refer to a communication standard protocol, which may include, for example, an LTE protocol, an NR protocol, and a protocol applied to a future communication system, and the disclosure is not limited in this regard.

The “multiple” and “plurality of” referred to herein means two or more. The term “and/or” herein describes an association relationship between associated objects, which means that there can be three relationships. For example, A and/or B can mean A alone, both A and B exist, and B alone. In addition, the character “/” herein generally indicates that the associated objects are in an “or” relationship.

As referred to herein, “greater than or equal to” may mean greater than or equal to, or greater than, and “less than or equal to” may mean less than or equal to, or less than.

In addition, the step numbers described herein merely exemplify one possible execution order of steps. In some other embodiments, the above steps may also be executed without following the order of the numbers. For example, two steps with different numbers are executed simultaneously, or two steps with different numbers are executed in an order opposite to an order illustrated in the diagram, which is not limited in embodiments of the disclosure.

Those skilled in the art can appreciate that in one or more of the above examples, the functions described in the embodiments of the disclosure may be implemented by hardware, software, firmware, or any combination thereof. When implemented by software, the functions may be stored in a computer-readable medium or transmitted as one or more instructions or codes in the computer-readable medium. The computer-readable medium includes a computer storage medium and a communication medium, where the communication medium includes any medium that facilitates transfer of a computer program from one place to another, and the storage medium may be any available medium that can be accessed by a general-purpose computer or a special-purpose computer.

The foregoing elaborations are merely exemplary embodiments of the disclosure, and are not intended for limiting the disclosure. Any modification, equivalent replacement, and improvement made within the concept and principle of the disclosure shall fall within the protection scope of the disclosure.

What is claimed is:

1. A method for data transmission, the method being performed by a terminal device and comprising:
performing transmission using multiple resource pools on multiple carriers;
wherein the multiple carriers have a same subcarrier spacing, a same time division duplex (TDD) configuration, a same synchronization resource configuration, a same starting symbol available for sidelink (SL) transmission in a slot, and same number of symbols available for SL transmissions in a slot, and the multiple resource pools have a same physical sidelink feedback channel (PSFCH) period and a same corresponding bitmap.

2. A terminal device comprising:
a transceiver;
a processor coupled to the transceiver; and
a memory storing a computer program which, when executed by the processor, causes the terminal device to:
perform transmission using multiple resource pools on multiple carriers;
wherein the multiple carriers have a same subcarrier spacing, a same time division duplex (TDD) configuration, a same synchronization resource configuration, a same starting symbol available for sidelink (SL) transmission in a slot, and same number of symbols available for SL transmissions in a slot, and the multiple resource pools have a same physical sidelink feedback channel (PSFCH) period and a same corresponding bitmap.

3. A terminal device, comprising:
a transceiver;
a processor coupled to the transceiver; and
a memory storing a computer program which, when executed by the processor, causes the terminal device to:
exclude a first resource from a candidate resource set, in a case where the first resource in the candidate resource set or a resource corresponding to the first resource satisfies a first condition;
wherein the first condition comprises at least one of:
a physical sidelink feedback channel (PSFCH) resource determined according to the first resource is to cause that simultaneous PSFCH transmission exceeds a capability of simultaneous transmission;
the PSFCH resource determined according to the first resource is to cause that hybrid automatic retransmission request (HARQ) information to be fed back exceeds a carrying capability of a PSFCH;
the PSFCH resource determined according to the first resource is in conflict with a resource on which the terminal device is to perform PSFCH transmission; and
the terminal device does not support transmission on the first resource or on the resource corresponding to the first resource.

4. The terminal device of claim 3, wherein the resource corresponding to the first resource comprises: a periodic resource corresponding to the first resource;
wherein the first resource is represented as R(x,y), x indicates a time-domain position of the first resource, and y indicates a frequency-domain position of the first resource; and
wherein the periodic resource corresponding to the first resource is represented as R(x,y+j*Ptxlg), j is an integer belonging to [0,Cresel-1], Cresel is related to a random count value generated by the terminal device, Ptxlg represents number of logical slots converted from Ptx, and Ptx represents a resource reservation period for the terminal device.

5. The terminal device of claim 4, wherein the PSFCH resource determined according to the first resource comprises:
the PSFCH resource determined merely according to the first resource; or
the PSFCH resource determined according to one or more of the periodic resource corresponding to the first resource.

6. The terminal device of claim 3, wherein the computer program executed by the processor to cause the terminal device to exclude the first resource from the candidate resource set is executed by the processor to cause the terminal device to exclude the first resource from the candidate resource set, in the case where the first resource or the resource corresponding to the first resource satisfies the first condition and in a case where a priority class of data to be transmitted by the terminal device on a carrier triggered for reporting of the candidate resource set satisfies a second condition.

7. The terminal device of claim 6, wherein the second condition comprises at least one of:
the priority class of the data to be transmitted by the terminal device on the carrier triggered for reporting of the candidate resource set is lower than or equal to a threshold;
a relationship between the priority class of the data to be transmitted by the terminal device on the carrier triggered for reporting of the candidate resource set and a priority class of data transmitted on a carrier from which a resource has been selected satisfies a third condition; or
a relationship between the priority class of the data to be transmitted by the terminal device on the carrier triggered for reporting of the candidate resource set and a priority class of PSFCH transmission performed by the terminal device satisfies a fourth condition.

8. The terminal device of claim 3, wherein the PSFCH resource determined according to the first resource refers to a corresponding PSFCH resource determined according to at least one or more of: a time-domain position of the first resource, a frequency-domain position of the first resource, or a source identifier (ID) for the terminal device.

9. The terminal device of claim 3, wherein the PSFCH resource is a time-domain resource, a time-frequency resource, or a code-domain resource corresponding to a time-frequency resource.

10. The terminal device of claim 3, wherein:
the candidate resource set is an initialized resource set and contains all resources belonging to a resource pool for the terminal device within a resource selection window; or
the candidate resource set is a resource set subject to resource exclusion and contains resources remaining in the initialized resource set subject to resource exclusion.

11. The terminal device of claim 3, wherein in a case where the terminal device performs transmission using multiple resource pools on multiple carriers, the multiple carriers have a same subcarrier spacing, a same time division duplex (TDD) configuration, a same synchronization resource configuration, a same starting symbol available for sidelink (SL) transmission in a slot, and same number of symbols available for SL transmission in a slot, and the multiple resource pools have a same PSFCH period and a same corresponding bitmap.

12. The terminal device of claim 3, wherein the capability of simultaneous transmission is indicated to the terminal device by another terminal device.

13. The terminal device of claim 12, wherein the capability of simultaneous transmission is indicated by number of carriers, N1, and the number of the carriers, N1, indicates that simultaneous transmission on at most N1 carriers is supported or simultaneous PSFCH transmission on at most N1 carriers is supported.

14. The terminal device of claim 12, wherein the capability of simultaneous transmission is indicated via one or more carrier lists, wherein each of the one or more carrier lists indicates carriers simultaneous transmission on which is supported or indicates carriers simultaneous PSFCH transmission on which is supported.

15. The terminal device of claim 3, wherein the capability of simultaneous transmission is specified by a standard, configured by a network, or pre-configured.

16. The terminal device of claim 3, wherein the carrying capability of the PSFCH means a maximum number of bits carriable by the PSFCH.

17. The terminal device of claim 3, wherein that the PSFCH resource determined according to the first resource is in conflict with the resource on which the terminal device is to perform PSFCH transmission comprises that the PSFCH resource determined according to the first resource and the resource on which the terminal device is to perform PSFCH transmission overlap in a time domain.

18. The terminal device of claim 3, wherein the resource on which the terminal device is to perform PSFCH transmission is determined according to a resource over which data is received by the terminal device.

19. The terminal device of claim 3, wherein the resource on which the terminal device is to perform PSFCH transmission is determined according to a resource indicated via sidelink control information (SCI) received by the terminal device.

20. The terminal device of claim 3, wherein a cause that the terminal device does not support transmission on the first resource or on the resource corresponding to the first resource comprises at least one of: limitation in a number of carriers simultaneous transmission on which is supported by the terminal device, limitation in carrier aggregation (CA), or interruption due to radio frequency (RF) retuning.
